(19) United States
(12) Patent Application Publication
(10) Pub. No.: US 2026/0145906 A1
(43) Pub. Date: May 28, 2026

(54) TELESCOPIC LINE MODULE AND ELECTRONIC DEVICE

(71) Applicant: Shenzhen Baseus Technology Co., Ltd., Shenzhen (CN)

(72) Inventors: HUA-JUN YANG, Shenzhen (CN); Li Huang, Shenzhen (CN); Tian-Tian Li, Shenzhen (CN); Zhi-Chao Li, Shenzhen (CN); Guang-Bin Li, Shenzhen (CN)

(21) Appl. No.: 19/453,202

(22) Filed: Jan. 20, 2026

Related U.S. Application Data
(63) Continuation-in-part of application No. PCT/CN2025/140582, filed on Dec. 6, 2025.

(30) Foreign Application Priority Data
Jun. 17, 2025 (CN) 202521243914.0
Jul. 24, 2025 (CN) 202511032150.5
Jul. 24, 2025 (CN) 202521560437.0

(51) Int. Cl. B65H 75/44; B65H 75/40; G01D 5/14

(52) U.S. Cl. CPC B65H 75/4471; B65H 75/406; G01D 5/145; B65H 2553/22; B65H 2553/80

(57) ABSTRACT

Provided in the present application are a telescopic line module and an electronic device. In the present application, a winding reel is rotatably connected in the installation housing and rotates around a rotation axis; the wire is wound on the winding reel; a follower conducting component is disposed at the winding reel, the wire is electrically connected to the follower conducting component; a follower trigger component is disposed on the winding reel or the follower conducting component; in the case where the wire extends out of the installation housing or is retracted into the installation housing, the follower trigger component cooperates with a fixed detection component to generate an electrical signal reflecting the wire action.

### CROSS-REFERENCE TO RELATED APPLICATIONS

The present application claims the benefit of and priority to Chinese patent application NO. 202521243914.0, filed on Jun. 17, 2025, entitled “telescopic line module and electronic device”, in China National Intellectual Property Administration, Chinese patent application NO. 202511032150.5, filed on Jul. 24, 2025, entitled “control method based on wire action and electronic device capable of detecting wire action”, in China National Intellectual Property Administration, Chinese patent application NO. 202521560437.0, filed on Jul. 24, 2025, entitled “telescopic line module capable of detecting wire action and electronic device”, in China National Intellectual Property Administration, the entirety of which is incorporated herein by reference.

### FIELD

The present application relates to the field of data cables, and in particular relates to a telescopic line module and an electronic device.

### BACKGROUND

In the prior art, many electronic devices come with their own data cable and are stowed by winding them, and the data cables are released during use. However, the electronic device may not be intelligently controlled based on the winding or release of data cables.

Therefore, improvement is desired.

### SUMMARY

The present application provides a telescopic line module capable of detecting the wire action, which includes: an installation housing; a winding reel is rotatably connected in the installation housing and rotates around a rotation axis; a wire is wound on the winding reel, and one end of the wire extends out of the installation housing; a follower conducting component is disposed at the winding reel, and another end of the wire is electrically connected to the follower conducting component; a follower trigger component is disposed on the winding reel or the follower conducting component; wherein when the wire extends out of the installation housing or is retracted into the installation housing, the follower trigger component is configured to cooperate with a fixed detection component to generate an electrical signal reflecting the wire action.

The present application provides a telescopic line module, which includes: a wire; a rotation wheel, the wire is connected to the rotation wheel, the wire is wound around the rotation wheel or out of the rotation wheel; a sensing component is disposed at the rotation wheel, and the sensing component is configured to act with a corresponding trigger component to enable the control module to obtain a winding out signal of the wire when the wire is wound out of the rotation wheel.

The present application provides an electronic device, characterized in that the electronic device includes: a display module; a telescopic line module as described above, the display module is electrically connected to the sensing component of the telescopic line module, and the display module is used to display the winding out signal of the wire.

The present application provides an electronic device capable of detecting the wire action, which includes: a main body; a winding reel is rotatably connected in the main body to rotate around the rotation axis; a wire is wound on the winding reel, and one end of the wire may extend out of the main body; a follower conducting component is disposed at the winding reel, and another end of the wire is successively connected to the follower conducting component and the main body; a follower trigger component is disposed at the winding reel or the follower conducting component; wherein when the wire is in the wire stretching action of extending out of the main body or in the wire recycling action of retracting from the main body, the follower trigger component is used to cooperate with the fixed detection component to generate an electrical signal reflecting the wire action, and the main body is used to receive the electrical signal.

The beneficial effects of the present application are as follows: by modifying the data cable module, specifically by incorporating a follower trigger component on the winding reel or the follower conducting component, when the winding reel rotates relative to the installation housing (i.e., when the wire extends out of the installation housing or is retracted into the installation housing), such as during wire stretching action or wire recycling action, the follower trigger component works in conjunction with the fixed detection component to output an electrical signal indicating the wire action, this enables the data cable module and/or electronic device to determine the wire action based on the electrical signal, and further intelligent control may be carried out based on the wire action, thus enhancing user experience.

The present application further provides an electronic device capable of detecting the wire action, which includes: a main body; a wire winder with a winding reel, the winding reel is rotatably connected in the main body to rotate around the rotation axis, and the winding reel is used for winding the wire; a detection module is used to generate an electrical signal when the winding reel rotates relatively to the main body, the electrical signal includes feature data generated by the wire action on the winding reel; wherein the main body determines action command based on the feature data and a preset comparison relationship, the action command is executed to control the main body to complete a corresponding operation, and the comparison relationship includes a preset correspondence between the feature data and the action command.

The present application provides a control method based on wire action, the method is applied to an electronic device equipped with a wire winder, the method includes: obtaining an electrical signal through a detection module in the wire winder, wherein the electrical signal comprises feature data generated by the wire action in the wire winder; determining action command based on the feature data and a preset comparison relationship, wherein the comparison relationship comprises a preset correspondence between the feature data and action command; executing the action command to control the electronic device to complete a corresponding operation.

The present application further provides an electronic device capable of detecting wire action, the electronic device includes a memory and a processor, the memory is configured to store computer programs; the processor is coupled to the memory, and the processor is used to execute the computer programs to achieve the control method based on wire action as described above.

The present application further provides a computer readable storage medium, the computer readable storage medium stores program data, and when the program data is executed by the processor, the control method based on wire action as described above is implemented.

The beneficial effects of the present application are as follows: by modifying the wire winder, the present application enables the wire to move within the wire winder and be detected by the detection module to output the electrical signal indicating the wire action, this enables the electronic device to determine the wire action based on the electrical signal, and further intelligent control may be carried out based on the wire action, thus enhancing user experience

### BRIEF DESCRIPTION OF THE DRAWINGS

To more clearly illustrate the technical solutions in the embodiments of the present application, the accompanying drawings used in the description of the embodiments will be briefly introduced below. Obviously, the accompanying drawings described below are only some embodiments of the present application, for those skilled in the art, other drawings may be obtained based on these drawings without creative effort.

FIG. 1 is a schematic diagram of an electronic device of some embodiments of the present application from a first perspective;

FIG. 2 is a schematic diagram of the electronic device of some embodiments of the present application from a second perspective;

FIG. 3 is an exploded view of the electronic device provided by some embodiments of the present application;

FIG. 4 is a schematic diagram of components such as a rotation wheel, a trigger component, and a display module in the electronic device provided by some embodiments of the present application from a first perspective;

FIG. 5 is a schematic diagram of components such as the rotation wheel, the trigger component, and the display module in the electronic device provided by some embodiments of the present application from a second perspective;

FIG. 6 is a schematic diagram of a protection cover in the electronic device provided by some embodiments of the present application;

FIG. 7 is a schematic diagram of an upper cover in the telescopic line module provided by some embodiments of the present application;

FIG. 8 is a schematic diagram of the electronic device provided by some embodiments of the present application, excluding the upper cover and the protection cover;

FIG. 9 is a schematic diagram of a display module in the electronic device provided by some embodiments of the present application;

FIG. 10 is a schematic diagram of the electronic device provided by some embodiments of the present application, excluding the upper cover, the protection cover and the display module;

FIG. 11 is a schematic diagram of a rotation wheel and a wire in the electronic device provided by some embodiments of the present application;

FIG. 12 is a schematic diagram of a follower circuit board in the telescopic line module provided in some embodiments of the present application;

FIG. 13 is a schematic diagram of a trigger fixed circuit board in the telescopic line module provided by some embodiments of the present application from a first perspective;

FIG. 14 is a schematic diagram of the trigger fixed circuit board in the telescopic line module provided by some embodiments of the present application from a second perspective;

FIG. 15 is a schematic diagram of a lower cover in the telescopic line module provided in some embodiments of the present application;

FIG. 16 is a schematic diagram of a first locking portion in the telescopic line module provided by some embodiments of the present application;

FIG. 17 is a schematic diagram of a locking track and a second locking portion in the rotation wheel of the telescopic line module provided in some embodiments of the present application;

FIG. 18 is a schematic diagram of the wire in the telescopic line module provided in some embodiments of the present application;

FIG. 19 is a schematic diagram of the rotation wheel in the telescopic line module provided in some embodiments of the present application;

FIG. 20 is a schematic diagram of the coil spring in the telescopic line module provided in some embodiments of the present application;

FIG. 21 is a schematic diagram of the electronic device provided in some embodiments of the present application;

FIG. 22 is a schematic diagram of a data cable module in some embodiments as shown in FIG. 21;

FIG. 23 is a partial schematic diagram of the data cable module in the embodiment shown in FIG. 22;

FIG. 24 is a partial schematic diagram of the data cable module in the embodiment shown in FIG. 22;

FIG. 25 is an assembly diagram of a conducting component in some embodiments as shown in FIG. 23;

FIG. 26 is an assembly diagram of a conducting component in some embodiments as shown in FIG. 23;

FIG. 27 is an assembly diagram of a conducting component in some embodiments as shown in FIG. 23;

FIG. 28 is an assembly diagram of a conducting component in some embodiments as shown in FIG. 23;

FIG. 29 is an assembly diagram of a conducting component in some embodiments as shown in FIG. 23;

FIG. 30 is an assembly diagram of a conducting component in some embodiments as shown in FIG. 23;

FIG. 31 is a flowchart of a method provided in some embodiments of the present application;

FIG. 32 is a schematic diagram of the electronic device in some embodiments of the present application;

FIG. 33 is a schematic diagram of a computer readable storage medium in some embodiments of the present application.

### DETAILED DESCRIPTION

The present application will now be described in further detail with reference to the accompanying drawings and embodiments. The following embodiments are for illustrative purposes only and do not limit the scope of the present application. The following embodiments are only some embodiments of the present application and not all embodiments, all other embodiments obtained by those skilled in the art without creative effort are within the scope of protection of the present application.

Reference to “embodiments” in the present application means that particular features, structures, or features described in conjunction with the embodiments may be included in at least one embodiment of the present application. It is understood by those skilled in the art, both explicitly and implicitly, that the embodiments described in the present application may be combined with other embodiments.

In the absence of conflict, the embodiments and technical features in the embodiments of the present application may be combined with each other, and the detailed description in the specific embodiments should be understood as an explanation of the purpose of the present application and should not be regarded as an undue limitation on the present application.

In order to make the purpose, technical solutions and advantages of the embodiments of the present application clearer, the specific technical solutions of the present application will be described in further detail below in conjunction with the accompanying drawings in the embodiments of the present application. The following embodiments are used to illustrate the application, but are not intended to limit the scope of the present application.

In the embodiments of the present application, the orientation terms “up”, “down”, “left”, and “right” are defined relative to the orientation in which the components are schematically placed in the accompanying drawings. These orientation terms are relative concepts used for description and clarification relative to the orientation in which the components are schematically placed in the accompanying drawings and may change accordingly depending on the orientation in which the components are placed in the accompanying drawings.

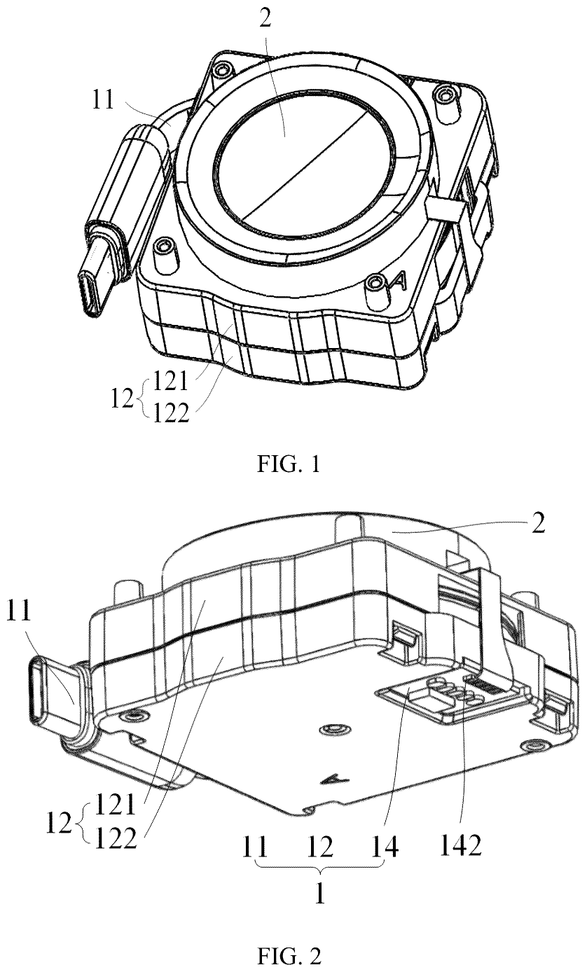

FIG. 1 to FIG. 5 illustrate a telescopic line module 1 (i.e., a data cable module, which may also be referred to as a wire winder) in accordance with some embodiments of the present application, the telescopic line module 1 includes a wire 11, a rotation wheel 13, and a sensing component 135. The wire 11 may be connected to the rotation wheel 13. The wire 11 may be wound on the rotation wheel 13 (i.e., the wire 11 is wrapped around the rotation wheel 13) or wound out of the rotation wheel 13 (i.e., the wire 11 is released from the rotation wheel 13). The sensing component 135 may be disposed at the rotation wheel 13, and the sensing component 135 is used to act with a corresponding trigger component 142 to cause a control module to obtain winding out signal of the wire 11 when the wire 11 is wound out of the rotation wheel 13. The sensing component 135 may also act with the corresponding trigger component 142 to cause the control module to obtain a winding signal of the wire 11 when the wire 11 is wrapped around the rotation wheel 13.

In the embodiments of the present application, unless otherwise explicitly specified and limited, the term “connection” should be interpreted broadly. For example, “connection” may be a fixed connection, a detachable connection, or an integral part; it may be a direct connection or an indirect connection through an intermediate medium.

In some embodiments of the present application, the telescopic line module 1 may be directly a separate component to be installed on an electronic device such as a mobile power supply, an adapter, a row plug. The telescopic line module 1 may also be a component in an electronic device, which is not limited by some embodiments of the present application.

In some embodiments of the present application, the telescopic line module 1 may include the wire 11 (i.e., data cable). The wire 11 may be used to connect a charging interface. The type of the charging interface may be a USB Type-C interface, a Lightning interface, a Micro USB interface, or even other types, and the embodiments of the present application are not limited. In one implementation method provided by some embodiments of the present application, the type of the charging interface is a USB Type-C interface.

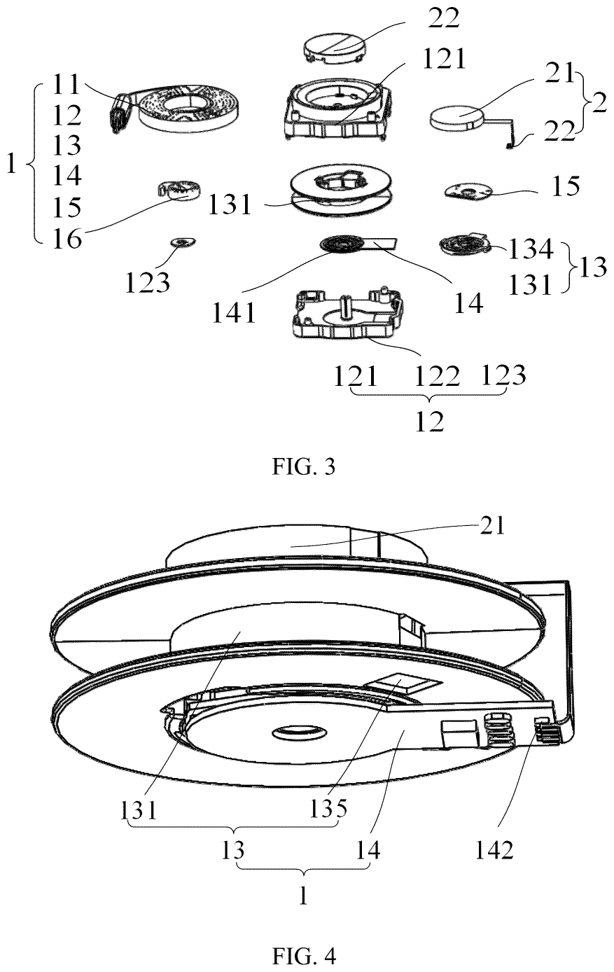

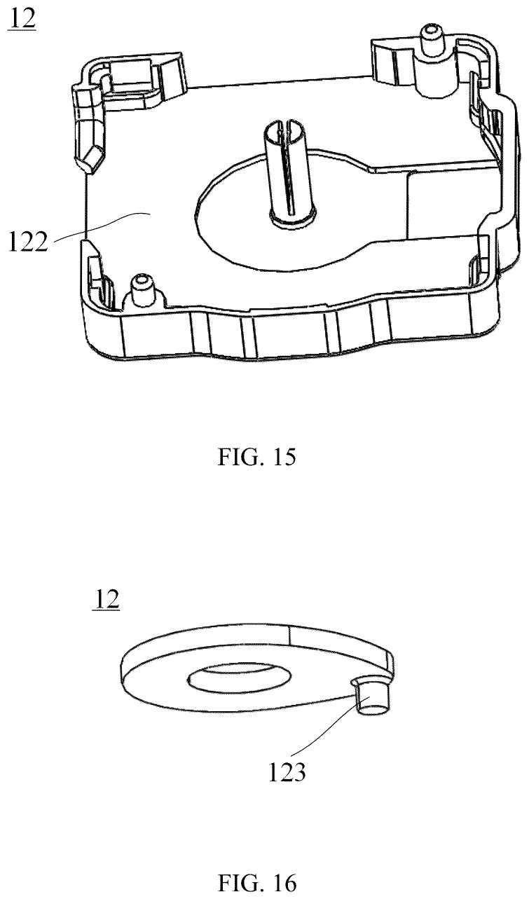

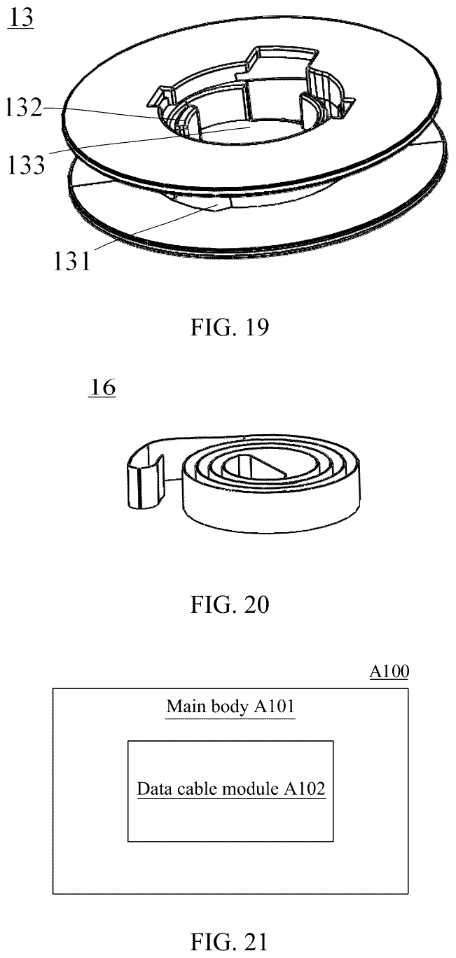

Referring to FIG. 3, FIG. 15, FIG. 19 and FIG. 20, in some embodiments of the present application, the rotation wheel 13 may include a winding portion 131, a first positioning portion 132, a second positioning portion 133. The winding portion 131 may be used to wrap the wire 11. The first positioning portion 132 may be used to fix the coil spring 16. The second positioning portion 133 may position the rotation wheel 13 and rotate the rotation wheel 13. The rotation wheel 13 may also include other portions, for example, the rotation wheel 13 may also include a damping engagement portion, etc., which is not limited by the embodiments of the present application. On this basis, the wire 11 may also be connected to the rotation wheel 13. The wire 11 may be connected to the winding portion 131 of the rotation wheel 13. The wire 11 may be connected to the first positioning portion 132 of the rotation wheel 13. The wire 11 may be connected to the second positioning portion 133 of the rotation wheel 13, etc., which is not limited by some embodiments of the present application.

Referring to FIG. 3, FIG. 18 and FIG. 19, in some embodiments of the present application, the wire 11 may be connected to the rotation wheel 13, this refers to a part of the wire 11 being connected to the rotation wheel 13, for example, an end of the wire 11, another part of the wire 11 is wrapped around the rotation wheel 13 or out of the rotation wheel 13. Alternatively, the wire 11 may be non-detachably connected to the rotation wheel 13. For example, the wire 11 is bonded to the rotation wheel 13, or for example, the wire 11 is welded to the rotation wheel 13. Alternatively, the wire 11 may be detachably connected to the rotation wheel 13. For example, the wire 11 is threadedly connected to the rotation wheel 13, or for example, the wire 11 is snap connected to the rotation wheel 13, which is not limited by the embodiments of the present application.

In some embodiments of the present application, the sensing component 135 is disposed at the rotation wheel 13. The sensing component 135 may be disposed at the winding portion 131 of the rotation wheel 13, the sensing component 135 may be disposed at the first positioning portion 132 of the rotation wheel 13, the sensing component 135 may be disposed at the second positioning portion 133 of the rotation wheel 13, the sensing component 135 may be disposed at other portions of the rotation wheel 13, which is not limited by the embodiments of the present application.

In some embodiments of the present application, the sensing component 135 may be disposed at the rotation wheel 13, and the sensing component 135 is used to act with a corresponding trigger component 142 to cause the control module to obtain winding out signal of the wire 11 when the wire 11 is wound out of the rotation wheel 13. The manner in which the sensing component 135 and the corresponding trigger component 142 act may be a hall-sensing manner, e.g., the sensing component 135 is a magnet and the trigger component 142 is a hall element. The telescopic line module 1 receives an external power source such as a mobile power supply, or an adapter. The magnet generates a magnetic field under the action of the power supply, and the Hall element generates a hall signal under the action of the magnetic field, and the control module receives the hall signal to obtain the winding out signal of the wire 11. The manner in which the sensing component 135 and the corresponding trigger component 142 act may also be in other ways, for example, the sensing component 135 is a first inductive magnet, the trigger component 142 is a second inductive magnet, the first inductive magnet and the second inductive magnet repel each other magnetically, the first inductive magnet drives the second inductive magnet to move in a direction away from the first inductive magnet, and the control module receives a power signal of the movement of the second inductive magnet to obtain the winding out signal of the wire 11.

In some embodiments of the present application, the sensing component 135 may be disposed at the rotation wheel 13, and the sensing component 135 is used to act with a corresponding trigger component 142 to cause the control module to obtain the winding out signal of the wire 11 when the wire 11 is wound out of the rotation wheel 13. The winding out signal of the wire 11 may include optical signals, the winding out signal of the wire 11 may include the electrical signal, and the winding out signal of the wire 11 may include acoustic signals, etc., which is not limited by some embodiments of the present application.

In some embodiments of the present application, the sensing component 135 may be disposed at the rotation wheel 13, and the sensing component 135 is used to act with a corresponding trigger component 142 to cause the control module to obtain the winding out signal of the wire 11 when the wire 11 is wound out of the rotation wheel 13. The winding out signal of the wire 11 may characterize information about the current state of the wire 11, for example, the length of the wire 11 that is currently wound out; for example, the degree to which the wire 11 is currently wound out; for example, also, the current and voltage through which the wire 11 is currently being passed, which is not limited by some embodiments of the present application.

Some embodiments of the present application provide a telescopic line module 1, since the wire 11 is connected to the rotation wheel 13, the wire 11 may be wound around or out of the rotation wheel 13, the sensing component 135 may be disposed at the rotation wheel 13, and the sensing component 135 is used to act with a corresponding trigger component 142 to cause the control module to obtain the winding out signal of the wire 11 when the wire 11 is wound out of the rotation wheel 13, therefore, the user may intuitively obtain the current state information of the wire 11 by the winding out signal of the wire 11, such as the length of the wire 11 being wound out; for example, the degree of the wire 11 being wound out, etc. The user may make adaptive adjustments through the current state information of the wire 11, for example, by obtaining the current state information of the wire 11, it may be found that the wire 11 is not long enough to be wound out of the wire wheel, and it is necessary to continue to make the wire 11 to be wound out, this may improve the user experience. Compared with related technologies, the technical problem of the user being unable to obtain the winding out signal of the wire 11 of the telescopic line module 1, resulting in a poor user experience, the present application has the technical effect that the user experience may be enhanced by setting the sensing component 135, and the sensing component 135 is disposed at the rotation wheel 13, and the sensing component 135 is used to act with a corresponding trigger component 142 to cause the control module to obtain the winding out signal of the wire 11 when the wire 11 is wound out of the rotation wheel 13, it has the technical effect that the sensing component 135 and the corresponding trigger component 142 may act to enable the control module to obtain the winding out signal of the wire 11 to enhance the user experience.

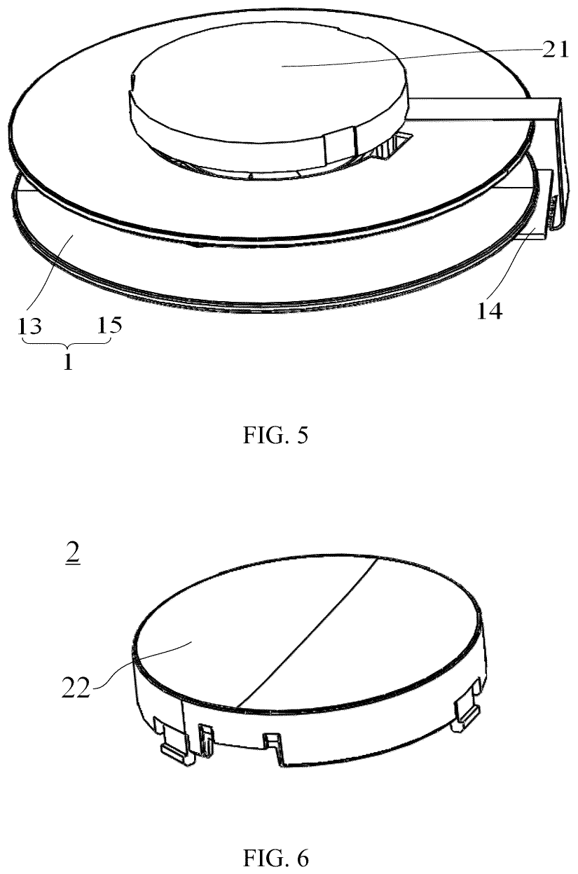

Referring to FIG. 3, FIG. 4 and FIG. 5, some embodiments of the present application provide a telescopic line module 1, one of the sensing component 135 and the trigger component 142 is a magnet, and another is a hall element.

In some embodiments of the present application, one of the sensing component 135 and the trigger component 142 is a magnet, and another is a hall element, the sensing component 135 may be a magnet, and the trigger component 142 may be a hall element; alternatively, the sensing component 135 is a hall element and the trigger component 142 is a magnet; which is not limited by some embodiments of the present application.

Specifically, the telescopic line module 1 receives external power, such as a portable power supply or an adapter. The magnet generates a magnetic field under the action of the power supply, and the hall element generates a hall signal under the action of the magnetic field, and the control module receives the hall signal to obtain the winding out signal of the wire 11.

Some embodiments of the present application provide a telescopic line module 1, by providing one of the sensing component 135 and the trigger component 142 as a magnet and another as a hall element, the magnet may sense the hall element to generate a hall signal, thus having core advantages such as high magnetic field strength detection, non-contact, high accuracy, and long life.

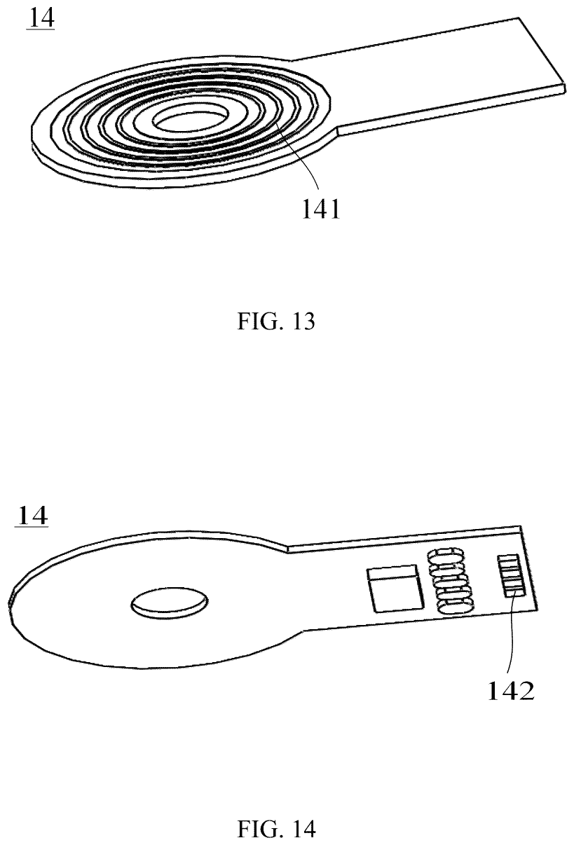

Referring to FIG. 3, FIG. 4, FIG. 13 and FIG. 14, some embodiments of the present application provide a telescopic line module 1, the telescopic line module 1 may also include a follower circuit board 15. The follower circuit board 15 includes a first follower end and a second follower end 151, the first follower end is disposed at the rotation wheel 13 and rotates with the rotation wheel 13, one end of the wire 11 is electrically connected to the first follower end, and the second follower end 151 is used to be electrically connected to the trigger fixed circuit board 14.

In some embodiments of the present application, the follower circuit board 15 may be part of the rotation wheel 13. In further embodiments, the sensing component 135 may be disposed at the follower circuit board 15. In further embodiments, the trigger component 142 may be disposed at other portions of the trigger fixed circuit board 14 such as the first fixing end 141. In further embodiments, the trigger component 142 may also be disposed on the housing 12. In further embodiments, the setting position of the sensing component 135 and the setting position of the trigger component 142 may be interchangeable.

In some embodiments of the present application, the telescopic line module 1 may also include a follower circuit board 15. The follower circuit board 15 may be a printed circuit board or a printed circuit board (PCB); the follower circuit board 15 may also be a flexible printed circuit board (FPC); the follower circuit board 15 may also be a rigid-flex board, which is not limited by some embodiments of the present application. In some embodiments, the follower circuit board 15 may also be a conducting structure and thus may also be referred to as a conducting component.

In some embodiments of the present application, the first follower end is disposed at the rotation wheel 13 and rotates with the rotation wheel 13, the first follower end may be disposed at the winding portion 131 of the rotation wheel 13; the first follower end may be disposed at the first positioning portion 132 of the rotation wheel 13; the first follower end may be disposed at the second positioning portion 133 of the rotation wheel 13; and the sensing component 135 may be disposed at other portions of the rotation wheel 13; which is not limited by some embodiments of the present application.

In some embodiments of the present application, the first follower end is disposed at the rotation wheel 13 and rotates with the rotation wheel 13, the first follower end may be non-detachably fixed to the rotation wheel 13, for example, the first follower end is bonded to the rotation wheel 13, or for example, the first follower end is welded to the rotation wheel 13; the first follower end may be detachably fixed to the rotation wheel 13, for example, the first follower end is threaded onto the rotation wheel 13, or for example, the first follower end is snap connected onto the rotation wheel 13, which is not limited by some embodiments of the present application.

In some embodiments of the present application, one end of the wire 11 is electrically connected to the first follower end, and the second follower end 151 is used to be electrically connected to the trigger circuit board, herein, it refers to the pathway formed between the wire 11, the follower circuit board 15, and the trigger circuit board, so that when the telescopic line module 1 receives an external power source, such as, for example, a mobile device; an electric current may flow between the wire 11, the follower circuit board 15, and the trigger circuit board.

Some embodiments of the present application provide a telescopic line module 1, by providing a follower circuit board 15, a first follower end of the follower circuit board 15 is provided on the rotation wheel 13 and rotates with the rotation wheel 13, an end of the wire 11 is electrically connected to the first follower end, and the second follower end 151 is electrically connected to the trigger fixed circuit board 14, so as to enable a pathway to be formed between the wire 11, the follower circuit board 15, and the trigger fixed circuit board 14, which has the technical effect of simple structure and easy implementation.

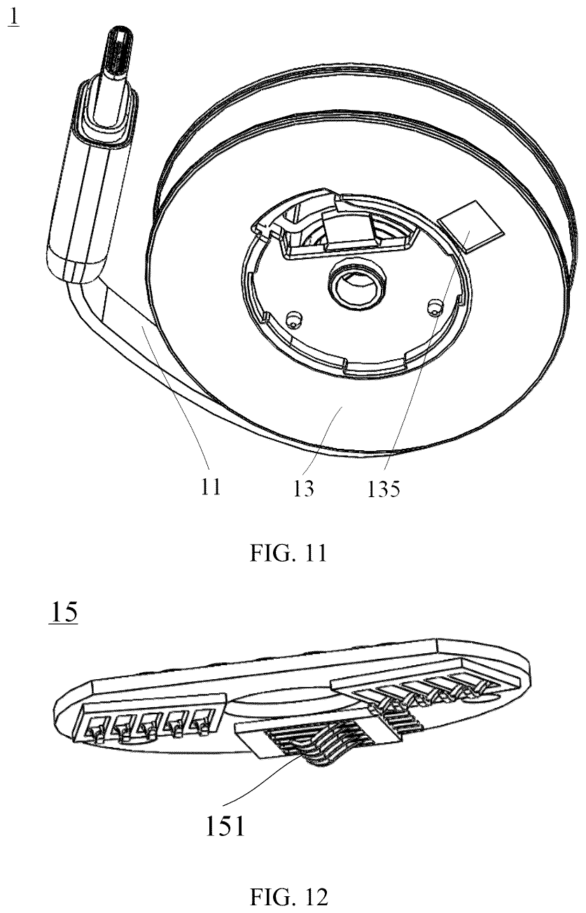

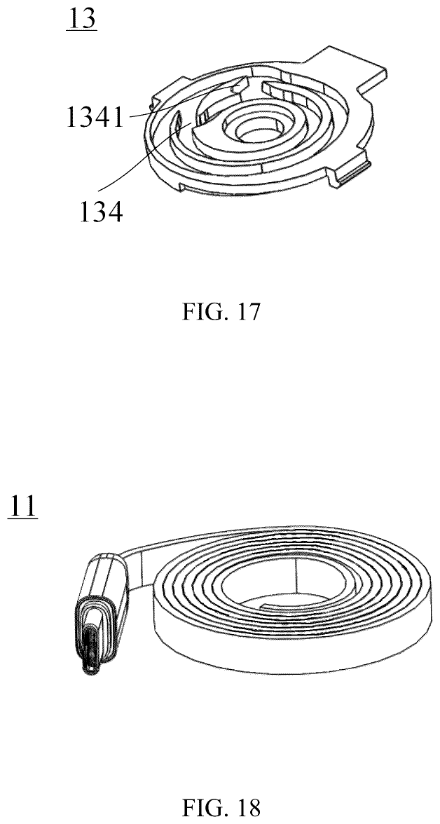

Referring to FIG. 11, FIG. 12, FIG. 13, FIG. 14, FIG. 15, FIG. 16, and FIG. 17, some embodiments of the present application provide a telescopic line module 1, the telescopic line module 1 may also include a trigger fixed circuit board 14, and the trigger fixed circuit board 14 may include a first fixing end 141 and a trigger component 142.

In some embodiments, the first fixing end 141 is rotatably connected to the second follower end 151. In some embodiments, a minimum distance between the trigger component 142 and the first fixing end 141 is greater than 2 millimeters and less than 10 millimeters.

In some embodiments of the present application, the telescopic line module 1 may also include a trigger fixed circuit board 14. The trigger fixed circuit board 14 may be a PCB; the trigger fixed circuit board 14 may also be a FPC; the trigger fixed circuit board 14 may also be a rigid flex board, which is not limited by some embodiments of the present application. In some embodiments, the trigger fixed circuit board 14 may also be a conducting structure and thus may also be referred to as a conducting component.

In some embodiments of the present application, the trigger fixed circuit board 14 may include a first fixing end 141 and a trigger component 142. The first fixing end 141 is rotatably connected to the second follower end 151. The first fixing end 141 may be a protrusion, and the second follower end 151 may be a rotating track, and the protrusion extends into the rotating track; the first fixing end 141 may also be a rotating track, and the second follower end 151 may be a protrusion, and the protrusion extends into the rotating track; which is not limited by some embodiments of the present application. In one implementation method provided by some embodiments of the present application, the first fixing end 141 is a rotating track, and the second follower end 151 is a protrusion.

In some embodiments of the present application, the trigger fixed circuit board 14 may include a first fixing end 141 and a trigger component 142, and the first fixing end 141 is rotatably connected to the first follower end. The first fixing end 141 and the first follower end contact when they are rotationally connected, and the manner of contact between the first fixing end 141 and the first follower end may be a rigid contact; the manner of contact between the first fixing end 141 and the first follower end may also be an elastic contact; which is not limited by some embodiments of the present application. In one implementation method provided by some embodiments of the present application, the first fixing end 141 is a rotating track, and the second fixing end is an elastic protrusion, and a direction of the elastic force of the elastic protrusion is a setting direction of the first fixing end 141 and the second follower end 151.

In some embodiments of the present application, the minimum distance between the trigger component 142 and the first fixing end 141 is greater than 2 millimeters and less than 10 millimeters; the minimum distance between the trigger component 142 and the first fixing end 141 may be 3 millimeters, 5 millimeters, or 9 millimeters; this is not limited by the embodiments of the present application.

The telescopic line module 1 provided in some embodiments of the present application may reduce the production cost of the trigger circuit board; the distance between the trigger component 142 and the first fixing end 141 is less than 10 millimeters, which may reduce the weight of the trigger circuit board and facilitate the lightweight structural design of the telescopic line module 1.

Referring to FIG. 3, FIG. 4, and FIG. 5, some embodiments of the present application provide a telescopic line module 1, the sensing component 135 is disposed at one side of the rotation wheel 13 close to the trigger component 142.

The telescopic line module 1 provided in some embodiments of the present application, by locating the sensing component 135 on the side of the rotation wheel 13 close to the trigger component 142, the phenomenon of the sensing component 135 not being able to act with the corresponding trigger component 142 or the effect of the action being weak due to the distance between the sensing component 135 and the trigger component 142 may be reduced.

Referring to FIG. 3, FIG. 4, and FIG. 5, some embodiments of the present application provide a telescopic line module 1, a concave portion is defined on one side of the rotation wheel 13 close to the trigger component 142, and the sensing component 135 is disposed in the concave portion.

In some embodiments of the present application, a depth of the concave portion may be less than a thickness of the sensing component 135; the depth of the concave portion may also be equal to the thickness of the sensing component 135; the depth of the concave portion may be greater than the thickness of the sensing component 135, which is not limited by some embodiments of the present application.

The telescopic line module 1 provided in some embodiments of the present application, by providing a concave portion on the side of the rotation wheel 13 close to the trigger component 142, and the sensing component 135 is disposed within the concave portion, the size of the telescopic line module 1 may be reduced.

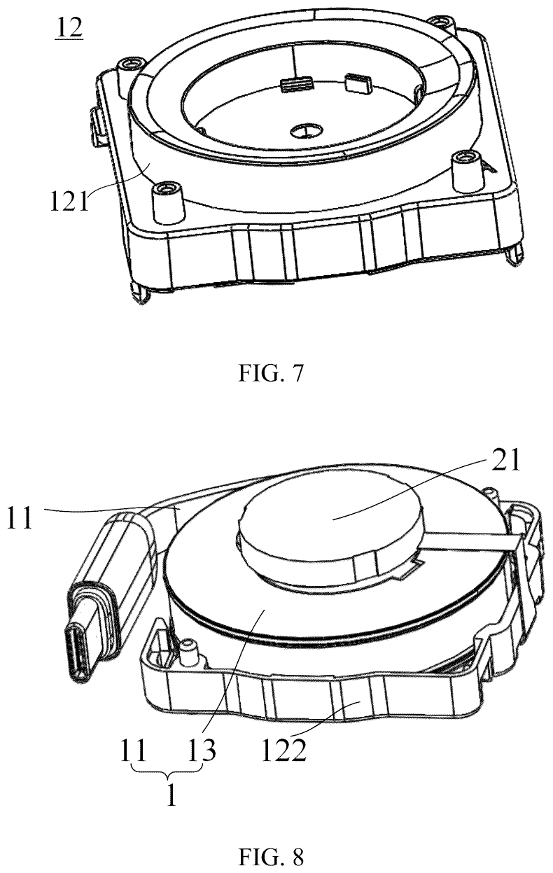

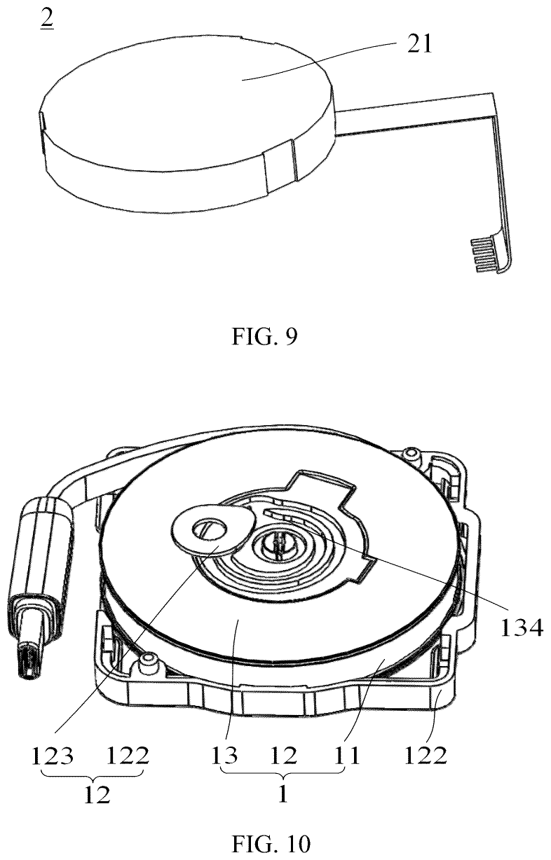

Referring to FIG. 6, FIG. 7, FIG. 8, FIG. 9 and FIG. 10, some embodiments of the present application provide a telescopic line module 1, the telescopic line module 1 further includes a housing 12, an accommodating cavity is formed inside the housing 12, the rotation wheel 13 is located within the accommodating cavity, and the wire 11 extends to the exterior of the housing 12.

In some embodiments of the present application, the accommodating cavity is formed inside the housing 12. The shape of the accommodating cavity may be a regular shape, for example, the shape of the accommodating cavity is a square, or for example, the shape of the accommodating cavity is a cylindrical shape; the shape of the accommodating cavity may also be an irregular shape, which is not limited by some embodiments of the present application. Similarly, the outer contour of the housing 12 may be a regular shape, for example, the outer contour shape of the housing 12 is a square shape, or for example, the outer contour shape of the housing 12 is a cylindrical shape; the outer contour shape of the housing 12 may be an irregular shape, which is not limited by some embodiments of the present application.

In some embodiments of the present application, the accommodating cavity is formed inside the housing 12, the housing 12 may be integrally formed and form the accommodating cavity; the housing 12 may also be molded separately and form the accommodating cavity; which is not limited by some embodiments of the present application. In one implementation method provided by some embodiments of the present application, the housing 12 includes an upper cover 121 and a lower cover 122, and the upper cover 121 and the lower cover 122 snapping together to form the accommodating cavity.

In some embodiments of the present application, the wire 11 may extend outside the housing 12. It should be explained that the wire 11 may extend outside the housing 12 through a through hole on the housing 12.

The telescopic line module 1 provided in some embodiments of the present application, by setting the housing 12 such that the rotation wheel 13 is located in the accommodating cavity, the housing 12 may protect the rotation wheel 13.

Referring to FIG. 10, FIG. 11, FIG. 15, FIG. 16 and FIG. 17, some embodiments of the present application provide a telescopic line module 1, the telescopic line module 1 further includes a coil spring 16 and a locking structure, the coil spring 16 is disposed at the rotation wheel 13, the locking structure includes a first locking portion 123 disposed on the housing 12, a second locking portion 1341 disposed on the rotation wheel 13, and the first locking portion 123 and the second locking portion 1341 cooperate to lock the wire 11 in the event the wire 11 is wound around or out of the rotation wheel 13.

In some embodiments of the present application, the first locking portion 123 and the second locking portion 1341 cooperate to lock the wire 11 in the event the wire 11 is wound around or out of the rotation wheel 13, the wire 11 may be locked to a target length; exemplarily, the wire 11 may be locked to a state of 10 centimeters, at which point, in the event that the wire 11 needs to be unlocked, then the user may continue to stretch the wire 11 such that the first locking portion 123 is separated from the second locking portion 1341, and in this way, the wire 11 may be unlocked.

In some embodiments of the present application, the first locking portion 123 may be a locking protrusion disposed in the accommodating cavity, and the second locking portion 1341 may be a locking groove disposed in the locking track 134 on the rotation wheel 13, the locking protrusion cooperates with the locking groove to lock the wire 11 in the event that the wire 11 is wound around the rotation wheel 13 or wound out of the rotation wheel 13. The first locking portion 123 may be a locking groove disposed on the locking track 134 within the accommodating cavity, and the second locking portion 1341 may be a locking protrusion disposed on the rotation wheel 13, the locking protrusion cooperates with the locking groove to lock the wire in the event that the wire 11 is wound around the rotation wheel 13 or wound out of the rotation wheel 13.

Some embodiments of the present application provide a telescopic line module 1, the first locking portion 123 cooperates with the second locking portion 1341 to lock the wire 11 in the event that the wire 11 is wound around the rotation wheel 13 or wound out of the rotation wheel 13, and so as to facilitate use by the user.

Furthermore, some embodiments of the present application provide an electronic device, and please refer to FIG. 1, FIG. 2, FIG. 3, FIG. 6 and FIG. 9, the electronic device includes a display module 2 and a telescopic line module 1 provided in some embodiments of the present application, the display module 2 is electrically connected to the sensing component 135 of the telescopic line module 1, and the display module 2 is used to display the winding out signal of the wire 11.

In some embodiments of the present application, the electronic device may be a mobile power supply (power bank), and the electronic device may be a laptop computer, etc., which is not limited by some embodiments of the present application. In one implementation method provided by some embodiments of the present application, the electronic device is a mobile power supply.

The electronic device provided in some embodiments of the present application, the display module 2 is electrically connected to the sensing component 135 of the telescopic line module 1, and the display module 2 is used to display the winding out signal of the wire 11, so that the user may more intuitively obtain the winding out signal of the wire 11 through the display module 2 to better enhance the user experience.

Referring to FIG. 1, FIG. 2, FIG. 3, FIG. 6 and FIG. 9, some embodiments of the present application provide an electronic device, the display module 2 includes a display element 21 and a protection cover 22, the protection cover 22 is disposed over the display element 21 to protect the display element 21, and the protection cover 22 is made of a transparent material.

In some embodiments of the present application, the protection cover 22 is made of a transparent material, specifically, the protection cover 22 may be made of transparent glass; the protection cover 22 may also be made of transparent plastic, which is not limited by some embodiments of the present application.

The electronic device provided in some embodiments of the present application, by locating the protection cover 22 on the display element 21, the display element 21 is protected, such that the probability of damage to the display element 21 may be reduced while the display element 21 is displayed.

Referring to FIG. 1, FIG. 2, FIG. 3, FIG. 6 and FIG. 9, some embodiments of the present application provide an electronic device, the electronic device also includes a control module, the display module 2 is electrically connected to the sensing component 135 through the control module, and the control module is used to obtain the winding out signal of the wire 11 and control the display module 2 to display the winding out signal of the wire 11.

The electronic device provided in some embodiments of the present application, by setting a control module, and the display module is electrically connected to the sensing component 135 through the control module, so that the control module is used to obtain the winding out signal of the wire 11 and control the display module 2 to display the winding out signal, in this way, the degree of intelligence of the electronic device may be improved.

In some embodiments, the control module is disposed in the telescopic line module.

The present application next describes an electronic device. In some embodiments, the electronic device may be set up using the electronic device described in the above embodiments. In some embodiments, the electronic device may be an electronic device as described in the above embodiments.

The electronic device may have a data cable to connect to an external device through the data cable to power or charge the external device. The electronic device may also be used to transfer data between the electronic device and the external device through the data cable. In some embodiments, the external device may also power or charge the electronic device through the data cable.

The electronic device may be a computer, cell phone, power bank, docking station, desktop charging station, outlet or power adapter, etc., the selection and design of the electronic device may be made according to the needs of the technicians in the field, as long as it comes with its own data cable.

In some embodiments, the data cable may be set up using the wire 11 described in the above embodiments. In some embodiments, the data cable may be the wire 11 as described in the above embodiments.

Referring to FIG. 21, FIG. 21 is a schematic diagram of the electronic device in some embodiments of the present application. The electronic device A100 may include a main body A101 and a data cable module A102 installed on the main body A101. The main body A101 may serve as the main structure of the electronic device A100, and may have at least some electronic components and at least some structural elements within the electronic device A100. The data cable module A102 may have a data cable that may be electrically connected to the main body A101. In some embodiments, the data cable module A102 may be the telescopic line module 1 in the above embodiments. In some embodiments, the data cable module A102 may be set up using the telescopic line module 1 in the above embodiments.

When in use, the data cable module A102 may release the data cable, and the data cable may be electrically connected to the external device to supply power or charge the external device, or the data cable may be electrically connected to the external device to achieve data transmission between the main body A101 and the external device. In some embodiments, the external device may also supply power or charge the main body A101 through the data cable.

When idle (i.e. not in use), the data cable module A102 may wrap the data cable to achieve data cable for storage.

In some embodiments, the user stretches the data cable in the data cable module A102 to release the data cable, thereby forming a wire stretching action. In some embodiments, the data cable module A102 wraps the data cable to recycle it back to the data cable module A102, thereby forming a wire recycling action.

In some embodiments, the wire action may include a wire stretching action and/or a wire recycling action.

In some embodiments, the electronic device A100, such as main body A101, may control the electronic device to perform operations corresponding to the wire stretching action and/or the wire recycling action.

In some embodiments, the electronic device A100, such as the main body A101, may have a display screen to display information corresponding to the data cable module A102 winding the data cable or releasing the data cable. The electronic device A100, such as main body A101, may display information corresponding to the wire stretching action or the wire recycling action. In some embodiments, the display screen may be set up using the display module 2 described in the above embodiments. In some embodiments, the display screen may be the display module 2 as described in the above embodiments.

In some embodiments, the electronic device A100, such as the main body A101, may have a speaker to broadcast information corresponding to the data cable module A102 winding the data cable or releasing the data cable. The electronic device A100, such as main body A101, may provide prompts for information corresponding to the wire stretching action or the wire recycling action.

In some embodiments, the electronic device A100, such as main body A101, may have indicator lights to reflect information corresponding to the data cable module A102 winding the data cable or releasing the data cable. The electronic device A100, such as main body A101, may provide prompts for information corresponding to the wire stretching action or the wire recycling action.

In some embodiments, the electronic device A100, such as main body A101, may also display device state corresponding to the wire stretching action or the wire recycling action.

In some embodiments, the electronic device A100, such as the main body A101, may reflect the information corresponding to the data cable module A102 winding the data cable or releasing the data cable by shutting down. In some embodiments, the main body A101 may reflect the information corresponding to the data cable module A102 releasing the data cable through power on.

In some embodiments, the data cable module A102 may be used separately to electrically connect to two electronic devices to realize an external connection and may enable data transfer between the two electronic devices and may also enable one electronic device to power or charge another electronic device. The data cable module A102 may also provide one of the two electronic devices with information the information corresponding to the data cable module A102 winding the data cable or releasing the data cable, to enable this electronic device to perform intelligent control based on this information.

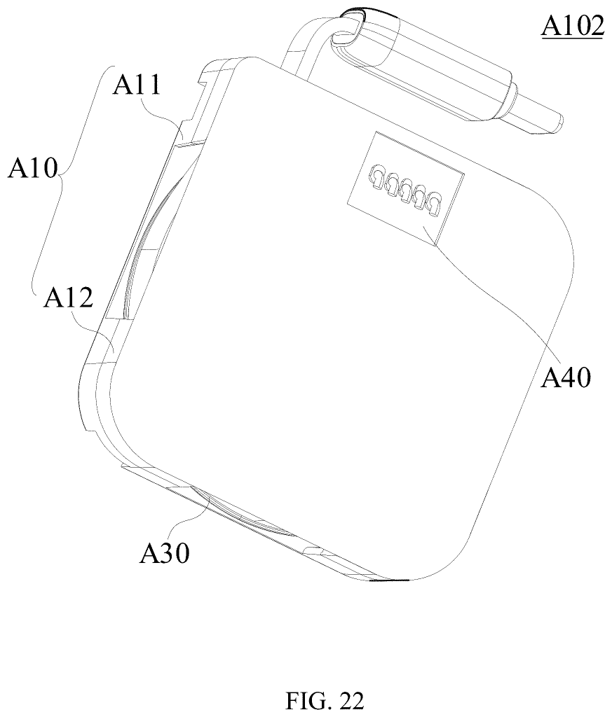

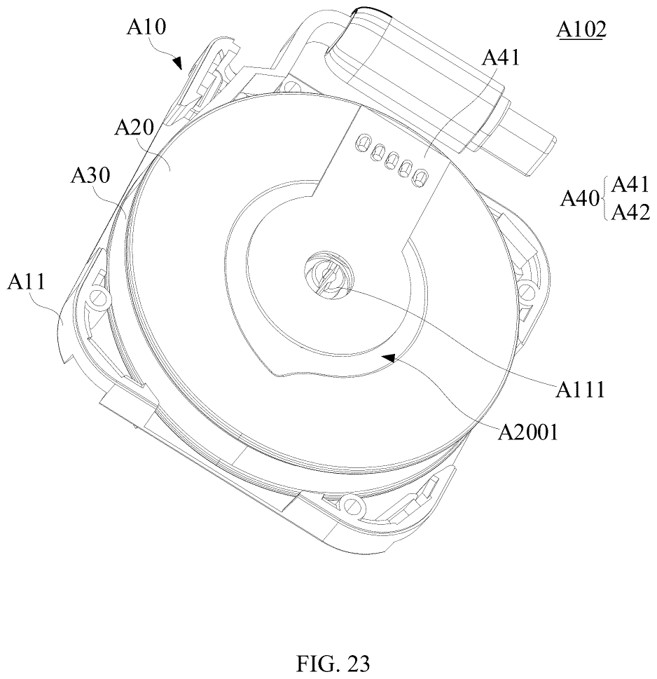

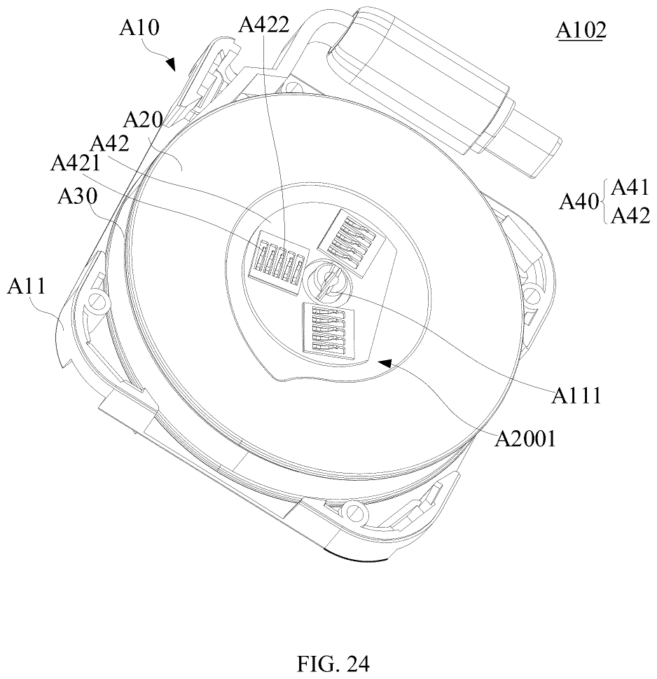

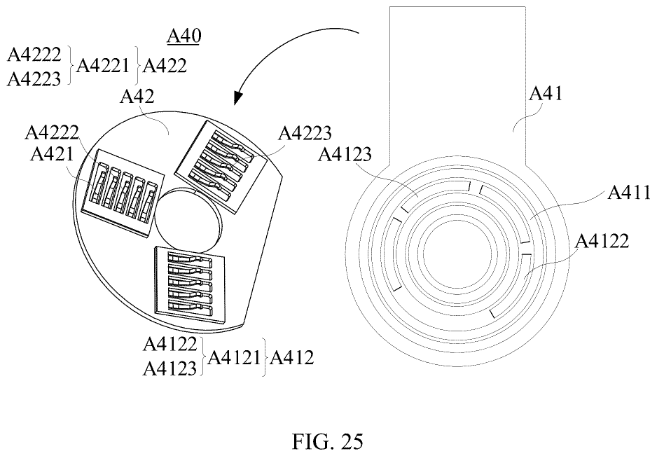

Referring to FIG. 22, FIG. 23 and FIG. 24, the data cable module A102 may include an installation housing A10, a winding reel A20 rotationally connected to the installation housing A10, a data cable A30 wrapped around the winding reel A20, and a conducting assembly A40 mounted to the installation housing A10 and the winding reel A20.

The installation housing A10 may be a housing structure for the data cable module A102 and may be mounted within the main body A101 and may be used to carry and mount the winding reel A20, the data cable A30, and the conducting assembly A40. When the main body A101 may play the role of the installation housing A10, the installation housing A10 may be omitted, and the structure provided on the installation housing A10 may be provided on the main body A101, and the main body A101 may also be provided in accordance with the connection relationship, the positional relationship, and the mating relationship of the installation housing A10 with the other structures, which will not be elaborated here. In some embodiments, at least a part of the structure of the installation housing A10 may be part of the main body A101 or integrated with the main body A101. The winding reel A20 may rotate relative to the installation housing A10 to rotate around the rotation axis, thereby winding the data cable A30 for storage and releasing the data cable A30 for easy use. The data cable A30 may be used for electrical connection with the external device, and data transmission with the external device, power supply or charging for the external device, and may also enable the external device to power or charge the electronic device A100. The data cable A30 may be electrically connected to the conducting assembly A40. The conducting assembly A40 may be electrically connected to the main body A101. The data cable A30 may be electrically connected to the main body A101 through the conducting assembly A40, thus achieving electrical connection between the data cable A30 and the main body A101.

In some embodiments, the installation housing A10 may be set up using the housing 12 described in the above embodiments. In some embodiments, the installation housing A10 may be the housing 12 as described in the above embodiments.

In some embodiments, the data cable module A102, such as data cable A30, may also be electrically connected to other data cables. In some embodiments, the data cable A30 may be released from the winding reel A20 or wound around the winding reel A20 to achieve length adjustment of the data cable A30.

In some embodiments, one end of the data cable A30 may be electrically connected to the external device to achieve external connection, and another end may be connected to the conducting assembly A40 for external connection through conducting assembly A40, such as connecting to the main body A101.

Referring to FIG. 22, the installation housing A10 may be a housing structure, a frame structure or a plate-shaped structure. In some embodiments, the installation housing A10 may include a first housing A11 and a second housing A12 connected together. The first housing A11 and the second housing A12 may be connected by welding, bonding, clamping, screwing, plug-in or by other methods familiar to those skilled in the art, which will not be elaborated here. The first housing A11 and the second housing A12 may be connected to form an installation space, so that other structures on the data cable module A102, such as the winding reel A20, the data cable A30, and the conducting assembly A40, may be installed within the installation space. In some embodiments, the data cable A30 may extend from outside the installation housing A10, for example, the installation space, into the installation housing A10, for example, the installation space, be wound around the winding reel A20, and may release part of the data cable A30 to outside the installation housing A10, for example, the installation space by rotating the winding reel A20, it is also possible to wind part of the data cable A30 into the installation housing A10, for example, the installation space, by rotating the winding reel A20.

In some embodiments, the first housing A11 may be set up using the upper cover 121 described in the above embodiments. In some embodiments, the first housing A11 may be the upper cover 121 as described in the above embodiments. In some embodiments, the second housing A12 may be set up using the lower cover 122 described in the above embodiments. In some embodiments, the second housing A12 may be the lower cover 122 as described in the above embodiments.

In some embodiments, the second housing A12 may be omitted. In some embodiments, the first housing A11 may be in a plate-shaped structure. In some embodiments, the first housing A11 may be a part of the main body A101 or an integrated structure with the main body A101.

Referring to FIG. 23 and FIG. 24, a rotating shaft A111 may be disposed on the first housing A11 to cooperate with the winding reel A20 and/or the conducting assembly A40. In some embodiments, the rotating shaft A111 may also be disposed on the second housing A12. In further embodiments, the first housing A11 and the second housing A12 may both be provided with a rotating shaft A111.

In some embodiments, the rotating shaft A111 may define the rotation axis.

Referring to FIG. 23 and FIG. 24, the winding reel A20 may be in a disk-shaped or plate-shaped structure as a whole and may be made of hard materials. The winding reel A20 may be rotatably connected to the installation housing A10, such as the first housing A11 and/or the second housing A12. In some embodiments, the winding reel A20 may be sleeved on the rotating shaft A111 to be rotatably connected to the installation housing A10, such as the first housing A11 and/or the second housing A12. The rotational connection method between the winding reel A20 and the installation housing A10, such as the first housing A11 and/or the second housing A12, is not limited to the rotating shaft A111, it may also be other methods, even those familiar to those skilled in the art, such as bearings, balls, etc., further, the rotation axis may be defined. In some scenarios, the winding reel A20 may be inserted into the holes or grooves on the installation housing A10, such as the first housing A11 and/or the second housing A12, to achieve rotational connection. In some scenarios, the winding reel A20 may be rotatably connected to the rotating shaft A111.

In some embodiments, the winding reel A20 may be set up using the rotation wheel 13 described in the above embodiments. In some embodiments, the winding reel A20 may be the rotation wheel 13 as described in the above embodiments.

Referring to FIG. 22, FIG. 23 and FIG. 24, the conducting assembly A40 may include a fixed conducting component A41 disposed on the installation housing A10, such as the second housing A12, and a follower conducting component A42 disposed on the winding reel A20. The fixed conducting component A41 is electrically connected to the follower conducting component A42, the fixed conducting component A41 may be electrically connected to the main body A101, and the follower conducting component A42 may be electrically connected to the data cable A30, thereby enabling the main body A101, the fixed conducting component A41, the follower conducting component A42 and the data cable A30 to be electrically connected in sequence. The setting of the fixed conducting component A41 and the follower conducting component A42 enables the main body A101 and the data cable A30 to achieve electrical connection when the installation housing A10 and the winding reel A20 are relatively rotating, or when the installation housing A10 and the winding reel A20 are relatively stationary. In further embodiments, the setting of sequential electrical connection of the main body A101, the fixed conducting component A41, the follower conducting component A42 and the data cable A30 may facilitate power supply (or charging) and/or data transmission.

In some embodiments, the conducting assembly A40 may include a trigger fixed circuit board 14 and a follower circuit board 15 as described in the above embodiments. In some embodiments, the fixed conducting component A41 may be set up using the trigger fixed circuit board 14 described in the above embodiments. In some embodiments, the fixed conducting component A41 may be the trigger fixed circuit board 14 as described in the above embodiments. In some embodiments, the follower conducting component A42 may be set up using the follower circuit board 15 described in the above embodiments. In some embodiments, the follower conducting component A42 may be the follower circuit board 15 as described in the above embodiments.

In some embodiments, the data cable module A102 may be externally connected through the end of the data cable A30 that is not connected to the follower conducting component A42 and may also be externally connected through the follower conducting component A42, for example, electrically connected to other electronic devices. In some embodiments, the data cable module A102 may be externally connected by cooperating with the fixed conducting component A41 through the follower conducting component A42, for example, electrically connected to the main body A101.

In some embodiments, when the winding reel A20 rotates relatively to the installation housing A10, such as the second housing A12, it may rotate around the rotation axis, thereby causing the follower conducting component A42 to rotate relative to the fixed conducting component A41 and also rotate around the rotation axis, further connecting the main body A101, the fixed conducting component A41, the follower conducting component A42, and the data cable A30 in sequence, the fixed conducting component A41 outputs an electrical signal indicating the wire action in cooperation with the follower conducting component A42. In further embodiments, the fixed conducting component A41 may output the electrical signal indicating the wire action to the main body A101 or a device electrically connected to the fixed conducting component A41. In some embodiments, the device electrically connected to the fixed conducting component A41 may also be disposed on the data cable module A102 or even be part of the data cable module A102. The function of the device that is electrically connected to the fixed conducting component A41 may be achieved by the data cable module A102 receiving the electrical signal indicating the wire action.

It may be understood that the circuit that outputs the electrical signal indicating the wire action may be different from the circuit that supplies power (or charges) and/or transmits data, that is, the electrical signal indicating the wire action is not transmitted through the circuit that supplies power (or charges) and/or transmits data. In some embodiments, the electrical signal may be the winding out signal in the above embodiments. In some embodiments, the optical signals and the acoustic signals, etc. in the above embodiments may be converted into the electrical signal recorded in the above embodiments for output and may be output to the main body A101 or the device or the data cable module A20 electrically connected to the fixed conducting component A41.

In addition, the wire action is closely related to the rotation direction of the winding reel A20, and in the case where the electrical signal may indicate the wire action, it may also indicate the rotation direction.

In some embodiments, the rotation direction may include a first rotation direction for winding the data cable A30 around the winding reel A20, and a second rotation direction for releasing the data cable A30 from the winding reel A20. The first rotation direction corresponds to the wire recycling action, and the second rotation direction corresponds to the wire stretching action.

In further embodiments, the electrical signal indicating the wire recycling action may simultaneously indicate the first rotation direction.

In further embodiments, the electrical signal indicating the wire stretching action may simultaneously indicate the second rotation direction.

In some embodiments, the main body A101 or the device electrically connected to the fixed conducting component A41 may respond to the electrical signal and generate an action command corresponding to the wire action to control the electronic device A100, such as the data cable module A102.

In some embodiments, the main body A101 may respond to the electrical signal and generate an action command corresponding to the wire action to control the electronic device A100. In some embodiments, the main body A101 may generate the action command corresponding to the wire recycling action to control the electronic device A100 to shut down. In some embodiments, the main body A101 may generate the action command corresponding to the wire stretching action to control the electronic device A100 to prompt the battery level.

In some embodiments, the data cable module A102 or the main body A101 is used to generate a first action command corresponding to the wire recycling action based on electrical signal, and/or a second action command corresponding to the wire stretching action based on electrical signal. The main body A101 may be controlled through the first action command and/or the second action command. In some embodiments, the main body A101 may be used to execute the first action command to control the electronic device A100 to shut down. In some embodiments, the main body A101 may be used to execute the second action command to control the electronic device A100 to prompt the battery level.

In some embodiments, the fixed conducting component A41 may be a part of the installation housing A10, such as the second housing A12, and further may be replaced by other structures on the installation housing A10, such as the second housing A12, to achieve the function of the fixed conducting component A41. In some embodiments, the follower conducting component A42 may be a part of the winding reel A20, and further, it may also be replaced by other structures on the winding reel A20 to achieve the function of the follower conducting component A42.

In some embodiments, the fixed conducting component A41 and the follower conducting component A42 may be arranged along the rotation axis. In some embodiments, the fixed conducting component A41 and the follower conducting component A42 may be arranged relatively along the rotation axis. In some embodiments, the follower conducting component A42 may be arranged along the rotation axis on the side of the winding reel A20 facing the fixed conducting component A41.

In some embodiments, an accommodating slot A2001 may be defined on the winding reel A20 to accommodate the follower conducting component A42. The setting of the accommodating slot A2001 may reduce the thickness of the winding reel A20 on the rotation axis, thereby reducing the thickness of the data cable module A102 on the rotation axis, making the data cable module A102 smaller and reducing the space occupation inside the electronic device A100, which may also make the electronic device A100 smaller. In further embodiments, at least a portion of the fixed conducting component A41 may also be located within the accommodating slot A2001.

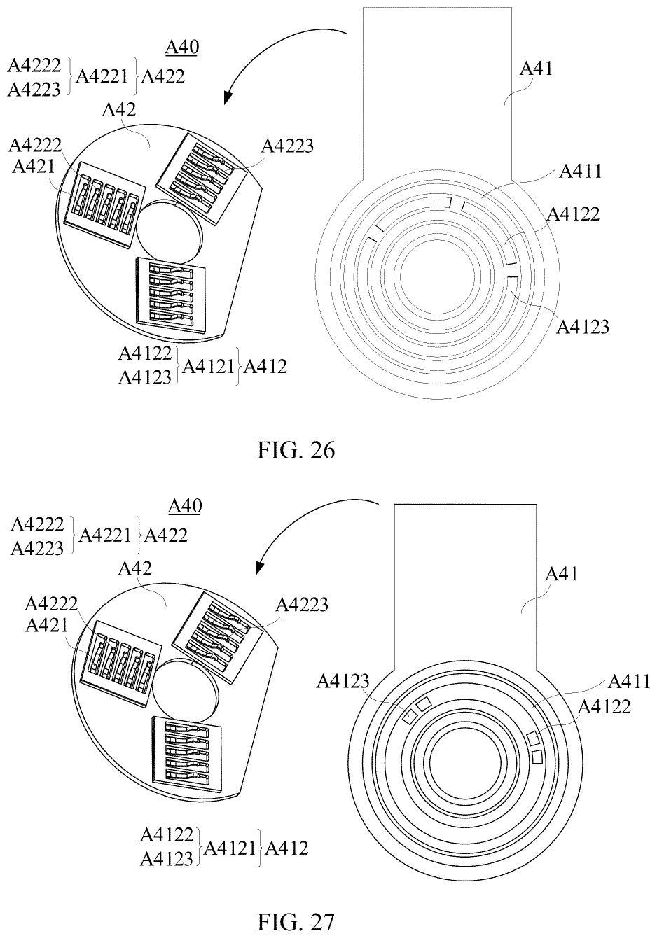

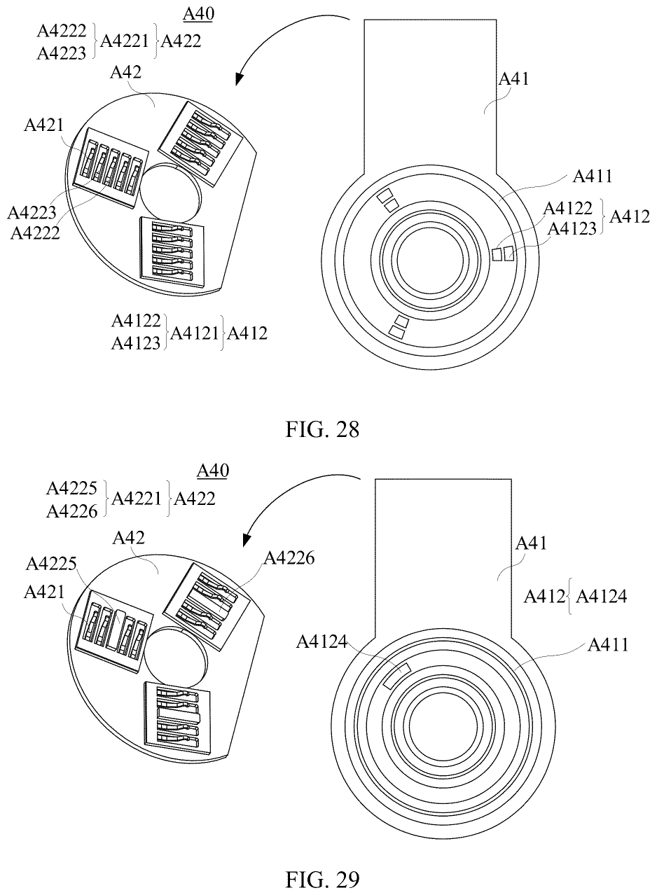

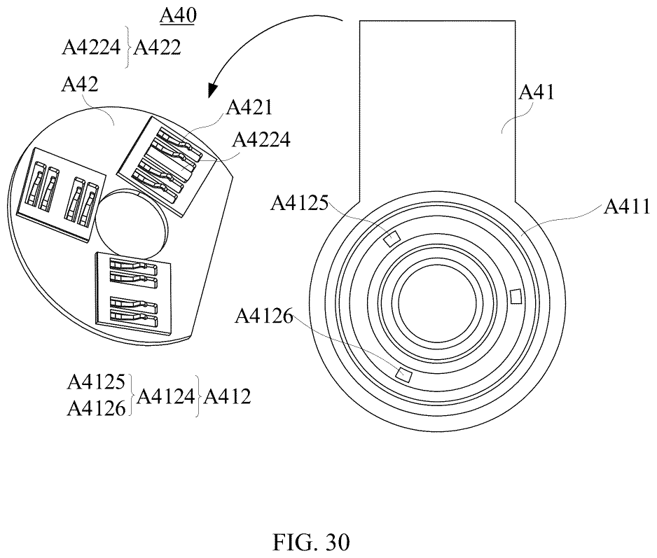

Referring to FIG. 25, FIG. 26, FIG. 27, FIG. 28, FIG. 29, FIG. 30, the fixed conducting component A41 may be flipped in the direction indicated by the arrow, and is arranged opposite to the follower conducting component A42, and may achieve electrical connection.

The fixed conducting component A41 may include the conducting wire rail A411 and the fixed detection component A412. The conducting wire rail A411 extends in the circumferential direction around the rotation axis to form a ring, which may be used to electrically connect with the follower conducting component A42, achieving the electrical connection between the fixed conducting component A41 and the follower conducting component A42, and further realizing the sequential electrical connection of the main body A101, the fixed conducting component A41, the follower conducting component A42 and the data cable A30. The fixed detection component A412 is used in conjunction with the follower conducting component A42 to enable the fixed conducting component A41 to output the electrical signal. In some embodiments, the electrical signal may be generated by the fixed detection component A412 and output by the fixed conducting component A41, or transmitted from the fixed detection component A412 through the follower conducting component A42 to the fixed conducting component A41 and output by the fixed conducting component A41. In some embodiments, the electrical signal may be transmitted through the fixed detection component A412 and then output by the fixed conducting component A41. In some embodiments, the fixed detection component A412 may trigger the fixed conducting component A41 to output the electrical signal. In some embodiments, the fixed detection component A412 may trigger the follower conducting component A42 to generate the electrical signal, and the electrical signal is transmitted to the fixed conducting component A41 and output by the fixed conducting component A41.

In some embodiments, the conducting wire rail A411 may be set up using the first fixed end 111 described in the above embodiments. In some embodiments, the conducting wire rail A411 may be the first fixed end 111 as described in the above embodiments.

In some embodiments, the fixed detection component A412 may not be disposed on the fixed conducting component A41, but on the installation housing A10, or even on the main body A101.

The number of conducting wire rails A411 may be multiple and may be successively looped around the rotation axis, with intervals set. The number of conducting wire rails A411 may be matched with the number of wire strands in the data cable A30 to achieve a one-to-one electrical connection between the conducting wire rails A411 and the wire strands in the data cable A30. In further embodiments, electrical connection is achieved through the follower conducting component A42.

Based on the requirements of some scenarios, the number of conducting wire rails A411 and the number of wire strands within the data cable A30 may also be specially adjusted and do not match.

In some embodiments, the fixed detection component A412 may be set according to the arrangement of the conducting wire rail A411.

In some embodiments, the fixed detection component A412 may be set up using the sensing component 135 described in the above embodiments. In some embodiments, the fixed detection component A412 may be the sensing component 135 as described in the above embodiments.

In some embodiments, the fixed detection component A412 may be set up using the trigger component 142 described in the above embodiments. In some embodiments, the fixed detection component A412 may be the trigger component 142 as described in the above embodiments.

The follower conducting component A42 may include a conducting contact A421 and a follower trigger component A422. The conducting contact A421 may be in contact with the fixed conducting component A41, such as the conducting wire rail A411, to achieve electrical connection, in further embodiments, the conducting contact A421 may be elastically pressed against the fixed conducting component A41, such as the conducting wire rail A411, to achieve electrical connection. The follower trigger component A422 is used in conjunction with the fixed conducting component A41, such as the fixed detection component A412, to enable the fixed conducting component A41 to output the electrical signal. That is, when the winding reel A20 rotates relatively to the installation housing A10, such as the second housing A12, the fixed detection component A412 and the follower trigger component A422 approach or move away from each other, the fixed conducting component A41 outputs the electrical signal while the fixed detection component A412 is in cooperation with the follower trigger component A422. In some embodiments, when the fixed detection component A412 and the follower trigger component A422 approach each other, the cooperation between the conducting contact A421 and the fixed conducting component A41, such as the conducting wire rail A411, may achieve electrical connection between the fixed conducting component A41 and the follower conducting component A42, further realizing the sequential electrical connection of the main body A101, the fixed conducting component A41, the follower conducting component A42, and the data cable A30.

In some embodiments, the follower trigger component A422 is disposed on the winding reel A20.

In some embodiments, the follower trigger component A422 may be set according to the configuration of the conducting contact A421.

In some embodiments, the follower trigger component A422 may be set up using the trigger component 142 described in the above embodiments. In some embodiments, the follower trigger component A422 may be the trigger component 142 as described in the above embodiments.

In some embodiments, the follower trigger component A422 may be set up using the sensing component 135 described in the above embodiments. In some embodiments, the follower trigger component A422 may be the sensing component 135 as described in the above embodiments.

The number of conducting contacts A421 may be multiple and may be distributed around the rotation axis, with intervals set. The number of conducting contacts A421 may be matched with the number of wire strands in the data cable A30 to achieve a one-to-one electrical connection between the conducting contacts A421 and the wire strands in the data cable A30. The number of conducting contacts A421 may also be matched with the number of conducting wire rails A411 to achieve a one-to-one electrical connection between the conducting contacts A421 and the conducting wire rails A411.

In some embodiments, the conducting contact A421 may be set up using the second follower end 151 described in the above embodiments. In some embodiments, the conducting contact A421 may be the second follower end 151 as described in the above embodiments.

Based on the requirements of some scenarios, the number of conducting contacts A421, the number of wire strands within the data cable A30, and the number of conducting wire rails A411 may also be specially adjusted and do not match.

For example, a plurality of conducting contacts A421 may be abut against one conducting wire rail A411 to achieve electrical connection. For example, a plurality of conducting contacts A421 are electrically connected to one wire strand within the data cable A30.

For example, a certain number of conducting contacts A421 and a certain number of conducting wire rails A411 are not electrically connected to the data cable A30, that is, the electrical connection is disconnected, which is used to transmit the electrical signal between the fixed conducting component A41 and the follower conducting component A42, in further embodiments, a certain number of conducting contacts A421 and a certain number of conducting wire rails A411 are matched and electrically connected to the fixed detection component A412 and/or the follower trigger component A422.

It may be understood that the position of the conducting contact A421 may be interchanged with the position of the conducting wire rail A411, so that the fixed conducting component A41 and the follower conducting component A42 are electrically connected to the conducting wire rail A411 through the conducting contact A421. In addition, the electrical connection between the fixed conducting component A41 and the follower conducting component A42 is not limited to the coordination between the conducting contact A421 and the conducting wire rail A411, and may also be achieved through other methods such as protrusions and protrusions, balls, protrusions and grooves, etc., which will not be repeated.

In some embodiments, the electrical signal may be generated by the follower trigger component A422 and transmitted to the fixed conducting component A41 through the follower conducting component A42, which is then output by the fixed conducting component A41. In some embodiments, the electrical signal may be transmitted through the follower trigger component A422 and may also be transmitted to the fixed conducting component A41, which is output by the fixed conducting component A41. In some embodiments, the winding reel A20 generates the electrical signal, which is transmitted through the follower trigger component A422 and may be transmitted to the fixed conducting component A41 for output. In some embodiments, the electrical signal may be transmitted successively through the follower trigger component A422, the fixed detection component A412, and may also be transmitted to the fixed conducting component A41. In some embodiments, the electrical signal may be transmitted successively through the fixed detection component A412 and the follower trigger component A422, and may also be transmitted to the fixed conducting component A41 through the follower conducting component A42. In some embodiments, the electrical signal may be generated by the fixed conducting component A41, such as the fixed detection component A412, and transmitted through the follower trigger component A422, and then transmitted from the follower conducting component A42 to the fixed conducting component A41. In some embodiments, the follower trigger component A422 may trigger the fixed conducting component A41, such as the fixed detection component A412, to generate the electrical signal, which is output by the fixed conducting component A41. In some embodiments, the follower trigger component A422 may trigger the follower conducting component A42 to output the electrical signal, which is then transmitted to the fixed conducting component A41 and output by the fixed conducting component A41.

In some embodiments, the fixed detection component A412 may include a sub fixed detection component A4121 that is electrically disconnected from the data cable A30, and the follower trigger component A422 may include a sub follower detection component A4221 that is electrically disconnected from the data cable A30. When the winding reel A20 rotates relatively to the installation housing A10, such as the second housing A12, the sub fixed detection component A4121 is in contact with the sub follower detection component A4221 for electrical connection, or separated and disconnected for electrical connection, the fixed conducting component A41 outputs the electrical signal when the sub fixed detection component A4121 is in cooperation with the sub follower detection component A4221.

In some embodiments, the sub fixed detection component A4121 may be in contact with the sub follower detection component A4221 for electrical connection to generate the electrical signal, or it may be electrically disconnected from the sub follower detection component A4221 to generate the electrical signal.

In some embodiments, the electrical signal may be generated based on the contact electrical connection between the sub fixed detection component A4121 and the sub follower detection component A4221, and output by the fixed conducting component A41. In some embodiments, the electrical signal may be generated by disconnecting the electrical connection between the sub fixed detection component A4121 and the sub follower detection component A4221 and then output by the fixed conducting component A41.

In some embodiments, a generator may be provided inside the winding reel A20, when the winding reel A20 rotates relatively to the installation housing A10, such as the second housing A12, the generator may generate the electrical signal in response to the rotation of the winding reel A20 relative to the installation housing A10, such as the second housing A12, the electrical signal may be transmitted through the contact between the sub follower detection component A4221 and the sub fixed detection component A4121, and further output by the fixed conducting component A41. The features of the positive and negative polarity, current intensity (which may characterize signal strength or current magnitude), duration (time length), and interval duration between electrical signal generated by the generator may vary depending on the wire action, and the features of the positive and negative polarity, current intensity, duration, and interval duration between the electrical signal of the electrical signal may be changed based on the design of the winding reel A20, such as the generator. The wire action may be determined based on the electrical signal. The method in which the winding reel A20 generates electrical signal is not limited to a generator, and other methods may also be used to generate the electrical signal corresponding to the wire actions, so that the recognition of wire actions may be achieved through the electrical signal.

In some embodiments, grounding may be provided within the winding reel A20, and the follower trigger component A422 may be grounded, such as the sub follower detection component A4221, i.e., the follower trigger component A422 may have a level signal (also referred to as a grounding electrical signal in this embodiment), such as the sub follower detection component A4221. The electrical signal may be transmitted through the contact between the sub follower detection component A4221 and the sub fixed detection component A4121, and further output by the fixed conducting component A41. The features of the positive and negative polarity, duration (time length), and interval duration between electrical signal generated by the generator may vary depending on the wire action, and the features of the positive and negative polarity, duration, and interval duration between the electrical signal of the electrical signal may be changed based on the design of the sub follower detection component A4221 and the sub fixed detection component A4121. The wire action may be determined based on the electrical signal. The method in which the winding reel A20 generates electrical signal is not limited to grounding, and other methods may also be used to generate the electrical signal corresponding to the wire actions, so that the recognition of wire actions may be achieved through the electrical signal.

In further embodiments, when the winding reel A20 rotates relatively to the installation housing A10, such as the second housing A12, the sub follower detection component A4221 has the electrical signal to output the electrical signal through the sub fixed detection component A4121.

In some embodiments, when the winding reel A20 rotates relatively to the installation housing A10, such as the second housing A12, the sub fixed detection component A4121 may be in constant contact with the sub follower detection component A4221 to achieve electrical connection.

In some embodiments, when the winding reel A20 rotates relatively to the installation housing A10, such as the second housing A12, the sub fixed detection component A4121 may change from a contact state to a non-contact state (i.e., from an electrically connected state to an electrically disconnected state) with the sub follower detection component A4221, or from a non-contact state to a contact state (i.e., from a disconnected electrical connection state to an electrical connection state). The electrical signal are related to the duration of the state, signal strength, and/or the transition pattern of the state, and the wire action may be determined based on the electrical signal reflecting the features.

For example, the arrangement patterns of the contact and non-contact states in the wire recycling action state may be different from the arrangement patterns of the contact and non-contact states in the wire stretching action state, and the wire action may be determined based on the electrical signal reflecting these differences.

For example, the signal strength in the wire recycling action state may be different from the signal strength in the wire stretching action state, and the wire action may be determined based on the electrical signal reflecting these differences.

In some embodiments, the electrical signal may be generated by the main body A101 or the data cable module A102, and then transmitted to the follower conducting component A42 through the fixed conducting component A41, subsequently, the sub follower detection component A4221 comes into contact with the sub fixed detection component A4121 and the electrical signal are transmitted to the fixed conducting component A41. In further embodiments, when the winding reel A20 rotates relatively to the installation housing A10, such as the second housing A12, the wire action is different, and the electrical signal output by the fixed conducting component A41, such as the sub fixed detection component A4121, may reflect different features such as positive and negative polarity, signal strength, signal layout pattern, duration of state, signal strength, and/or state transition pattern, therefore, the wire action may be determined based on the electrical signal.

Referring to FIG. 25 and FIG. 27, the follower conducting component A42 is provided with a plurality of sub follower detection components A4221 that are electrically connected to each other. The sub fixed detection component A4121 may include a first sub fixed detection component A4122 and a second sub fixed detection component A4123, and the first sub fixed detection component A4122 has a level signal, when the winding reel A20 rotates relatively to the installation housing A10, such as the second housing A12, the first sub fixed detection component A4122 and the second sub fixed detection component A4123 are electrically connected or disconnected through the plurality of sub follower detection components A4221, the electrical signal may include the level signal output by the second sub fixed detection component A4123. In some embodiments, the level signal may also reflect positive and negative polarities.

In some embodiments, the first sub fixed detection component A4122 may input a high-level signal, and then when the first sub fixed detection component A4122 and the second sub fixed detection component A4123 are electrically connected through the plurality of sub follower detection components A4221, the second sub fixed detection component A4123 outputs the electrical signal, such as the high-level signal. When the first sub fixed detection component A4122 and the second sub fixed detection component A4123 are disconnected through the plurality of sub follower detection components A4221, the second sub fixed detection component A4123 outputs the electrical signal, such as the low-level signal.

In some embodiments, the electrical signal such as a high-level signal may be formed by connecting the first sub fixed detection component A4122 to a power supply terminal. In some embodiments, the electrical signal such as a low-level signal may be formed by grounding the first sub fixed detection component A4122.

In some embodiments, the plurality of sub follower detection components A4221, electrically connected to each other, are distributed around the rotation axis, which may also adjust features such as the duration of the state and the state transition pattern. For example, the plurality of sub follower detection components A4221, electrically connected to each other, are distributed on the same circle around the rotation axis. The distances between any two adjacent sub follower detection components A4221 may be different to form an arrangement pattern that may reflect the wire action.

In some embodiments, the plurality of sub follower detection components A4221 are electrically connected to each other through the follower conducting component A42. In some embodiments, the plurality of sub follower detection components A4221 are electrically connected to each other through a fixed conducting component A41. In some embodiments, the plurality of sub follower detection components A4221 are electrically connected through the cooperation of the fixed conducting component A41 and the follower conducting component A42.

In some embodiments, the first sub fixed detection component A4122 and the second sub fixed detection component A4123 are distributed around the rotation axis, which may also adjust features such as the duration of the state and the state transition pattern. For example, the first sub fixed detection component A4122 and the second sub fixed detection component A4123 are distributed on the same circle around the rotation axis. The arrangement of the two sub follower detection components A4221 may form an arrangement pattern that reflects the wire action.

In some embodiments, the plurality of sub follower detection components A4221 may include a first sub follower detection component A4222 and a second sub follower detection component A4223. The distance between the first sub follower detection component A4222 and the rotation axis is the same as the distance between the second sub follower detection component A4223 and the rotation axis, that is, the first sub follower detection component A4222 and the second sub follower detection component A4223 are distributed around the rotation axis on the same circle.

In some embodiments, when the winding reel A20 rotates relatively to the installation housing A10, such as the second housing A12, the first sub fixed detection component A4122 and the second sub fixed detection component A4123 are electrically connected or disconnected through the first sub follower detection component A4222 and the second sub follower detection component A4223.

Referring to FIG. 28, the distance between the second sub follower detection component A4223 and the rotation axis is greater than the distance between the first sub follower detection component A4222 and the rotation axis, that is, the plurality of sub follower detection components A4221 may be partially distributed around the rotation axis on the same circle. Meanwhile, the distance between the second sub fixed detection component A4123 and the rotation axis is greater than the distance between the first sub fixed detection component A4122 and the rotation axis, that is, the plurality of sub fixed detection components A4121 may be partially distributed around the rotation axis on the same circle. This further enables the first sub fixed detection component A4122, the second sub fixed detection component A4123, the first sub follower detection component A4222 and the second sub follower detection component A4223 to work in coordination.

In some embodiments, the sub fixed detection component A4121 may be a wire rail, and the sub follower detection component A4221 may be a contact, and the electrical connection is achieved through the contact between the wire rail and the contact. In some embodiments, the sub fixed detection component A4121 may be set according to the conducting wire rail A411, and the sub follower detection component A4221 may be set according to the conducting contact A421. The coordination between the sub fixed detection component A4121 and the sub follower detection component A4221 may be set according to the coordination between the conducting wire rail A411 and the conducting contact A421. In some embodiments, the sub fixed detection component A4121 may be a contact, and the sub follower detection component A4221 may be a wire rail, and the electrical connection is achieved through the contact between the wire rail and the contact.

It may be understood that the coordination between the sub fixed detection component A4121 and the sub follower detection component A4221 is not limited to the methods listed here and may also be achieved through other methods such as protrusions and protrusions, balls, protrusions and grooves, etc., which will not be repeated.

Referring to FIG. 29, the fixed detection component A412 may include a sensor A4124, and the follower trigger component A422 may include a plurality of trigger components A4224, when the winding reel A20 rotates relatively to the installation housing A10, such as the second housing A12, the sensor A4124 and each trigger component A4224 approach or move away from each other, the sensor A4124 generates the electrical signal, and the electrical signal is then output through the fixed conducting component A41. By setting the plurality of trigger components A4224, the electrical signal may reflect the detection state of the trigger component A4224 detected by the sensor A4124 and the non-detection state of the trigger component A4224 not detected, and may also reflect the transition from the detection state to the non-detection state, or from the non-detection state to the detection state, and may even reflect the duration of the state, signal strength, and/or the state transition pattern, and the wire action may be determined based on the electrical signal reflecting the features.

In some embodiments, the sensor A4124 may be the sensing component 135 in the above embodiments. In some embodiments, the trigger component A4224 may be the trigger component 142 in the above embodiments.

In some embodiments, the plurality of trigger components A4224 are distributed circumferentially around the rotation axis, and the distances between partial trigger components A4224 are different, and the sensor A4124 generates the electrical signal based on the distances, which may reflect the differences in distances and thereby distinguish the wire actions.

In some embodiments, partial trigger components A4224 correspond to different detection indexes of the sensor A4124, and the sensor A4124 is used to generate the electrical signal reflecting distance and/or detection index.

In some embodiments, the trigger component A4224 may include a first sub trigger component A4225 and a second sub trigger component A4226. In some embodiments, the first sub trigger component A4225 and the second sub trigger component A4226 are distributed around the rotation axis, which may also adjust features such as the duration of the state and the state transition pattern. For example, the first sub trigger component A4225 and the second sub trigger component A4226 are distributed on the same circle around the rotation axis. The arrangement of the two trigger components A4224 may form an arrangement pattern that reflects the wire action.

In some embodiments, the distance between the second sub trigger component A4226 and the rotation axis is greater than the distance between the first sub trigger component A4225 and the rotation axis, that is, the plurality of trigger components A4224 may be partially distributed around the rotation axis on the same circle. Meanwhile, the plurality of sensors A4124 may be partially distributed around the rotation axis on the same circle.

In some embodiments, the sensor A4124 may also be multiple.

In some embodiments, the arrangement and/or distribution of the trigger component A4224 on the follower conducting component A42 may also refer to the arrangement and/or distribution of the sub follower detection component A4221, which will not be repeated here.

In some embodiments, the arrangement and/or distribution of the trigger component A4224 on the follower conducting component A42 may also refer to the arrangement and/or distribution of the sub follower detection component A4221, which will not be repeated here.

In some embodiments, the electronic device A100, such as the main body A101, may process the electrical signal, distinguish the wire actions, and then generate the action command corresponding to the wire actions to control the electronic device A100, such as the data cable module A102.

In some embodiments, the sensor A4124 may be a proximity sensor to generate the electrical signal when the trigger component A4224 approaches. In some embodiments, the proximity sensor may be a hall sensor, and the trigger component A4224 may be a magnetic component. In some embodiments, the magnetic strength (i.e., detection index) and distribution of the magnetic component may reflect the wire action. In some embodiments, the magnetic component may be a magnet as described in the above embodiments.

It may be understood that the settings, types, and methods of the sensor A4124 and the trigger component A4224 may be selected based on the needs of those skilled in the art, and will not be repeated here.

Referring to FIG. 30, the fixed detection component A412 may include a plurality of sensors A4124, and the follower trigger component A422 may include one trigger component A4224, when the winding reel A20 rotates relatively to the installation housing A10, such as the second housing A12, each sensor A4124 and the trigger component A4224 approach or move away from each other, the sensor A4124 generates the electrical signal, and the electrical signal is then output through the fixed conducting component A41.

In some embodiments, the sensor A4124 may include a first sensor A4125 and a second sensor A4126. In some embodiments, the first sensor A4125 and the second sensor A4126 are distributed around the rotation axis, which may also adjust features such as the duration of the state and the state transition pattern. For example, the first sensor A4125 and the second sensor A4126 are distributed on the same circle around the rotation axis. The arrangement of the two sensor A4124 may form an arrangement pattern that reflects the wire action.

In some embodiments, the distance between the second sensor A4126 and the rotation axis is greater than the distance between the first sensor A4125 and the rotation axis, that is, the plurality of sensors A4124 may be partially distributed around the rotation axis on the same circle. Meanwhile, the plurality of trigger components A4224 may be partially distributed around the rotation axis on the same circle.

It may be understood that the setting position of the sensor A4124 and the setting position of the trigger component A4224 may be interchangeable.

In some embodiments, the sensor A4124 may be set up using the sensing component 135 described in the above embodiments. In some embodiments, the sensor A4124 may be the sensing component 135 in the above embodiments.

In some embodiments, the trigger component A4224 may be set up using the trigger component 142 described in the above embodiments. In some embodiments, the trigger component A4224 may be the trigger component 142 in the above embodiments.

In some embodiments, the device electrically connected to the fixed conducting component A41 may process the electrical signal, distinguish the wire action, and then generate the action command corresponding to the wire action to control the electronic device A100, such as the data cable module A102.

Referring to FIG. 25, the first sub fixed detection component A4122 and the second sub fixed detection component A4123 may both be two, the two first fixed detection components A4122 and the two second fixed detection components A4123 may be arranged alternately in the circumferential direction of the rotation axis. In other embodiments, two first fixed detection components A4122 and two second fixed detection components A4123 may be arranged successively in the circumferential direction of the rotation axis.

Referring to FIG. 26, the first sub fixed detection component A4122 is two, and the second sub fixed detection component A4123 is one. In other embodiments, two second sub fixed detection components A4123 may be connected to form one. In other embodiments, the first sub fixed detection component A4122 is one, and the second sub fixed detection component A4123 is two. In other embodiments, two first sub fixed detection components A4122 may be connected to form one.

Referring to FIG. 25, at least one follower trigger component A422 has a level signal, when the winding reel A20 rotates relative to the installation housing A10, the plurality of fixed detection components A412 may be electrically connected or disconnected from the follower trigger component A422 in sequence, so that the data cable module A102 or the main body A101 may obtain the level signal of the wire action.

The following will describe a control method based on the wire action, this method may be applied to the data cable module A102 in the above embodiments, this method may also be applied to the electronic device A100 in the above embodiments, this method may also be applied to other electronic devices with a wire winder.

In some embodiments, in the method, the electronic device A100, such as the main body A102, may be controlled based on the wire action.

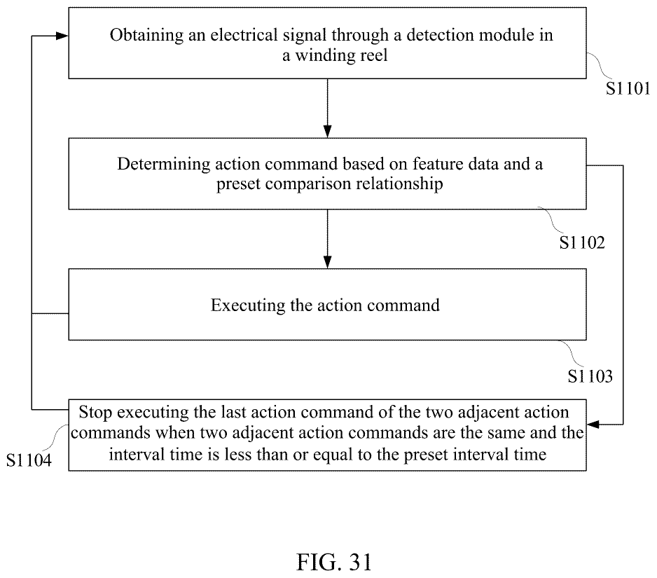

FIG. 31 is a flowchart of a method in some embodiments of the present application. The method may include the following steps:
At step S1101: obtaining an electrical signal through a detection module in a wire winder.

In some embodiments, the electrical signal may include feature data generated by the wire action in the wire winder.

In some embodiments, the feature data may include the positive and negative polarities of the electrical signal. In some embodiments, the electrical signal may include a sub signal sequence, and the feature data may include a positive and negative polarity sequence formed by the positive and negative polarities of each sub signal in the sub signal sequence. In some embodiments, the electrical signal may include a sub signal sequence, and the feature data may include a duration sequence formed by the duration of each sub signal in the sub signal sequence. In some embodiments, the electrical signal comprises a sub signal sequence, and the feature data comprises an interval duration sequence formed by the interval duration between two adjacent sub signals in the sub signal sequence. In some embodiments, the electrical signal includes a sub signal sequence, and the feature data includes a signal strength sequence formed by the signal strength of each sub signal in the sub signal sequence.

In some embodiments, the detection module may include the conducting component A40 in the above embodiments. In some embodiments, the conducting component A40 in the above embodiment may also be referred to as the detection module. In some embodiments, the detection module may include the follower trigger component A422 and the fixed detection component A412 in the above embodiments. In some embodiments, the follower trigger component A422 and the fixed detection component A412 in the above embodiments may form a detection module.

In some embodiments, the detection module may output the electrical signal indicating the wire action.

In some embodiments, when the winding reel A20 rotates relatively to the installation housing A10, such as the second housing A12, it may rotate around the rotation axis, thereby causing the follower conducting component A42 to rotate relative to the fixed conducting component A41 and also rotate around the rotation axis, further connecting the main body A101, the fixed conducting component A41, the follower conducting component A42, and the data cable A30 in sequence, the fixed conducting component A41 outputs an electrical signal indicating the wire action in cooperation with the follower conducting component A42. That is, the detection module may output the electrical signal indicating the wire action.

In some embodiments, step S1101 may be executed by the electronic device A100, such as the main body A101.
At step S1102: determining action command based on feature data and a preset comparison relationship.

In some embodiments, the comparison relationship may include a preset correspondence between the feature data and the action command. In some embodiments, the electrical signal may include a first electrical signal, and the first electrical signal may include a first feature data generated by the wire stretching action of stretching the wire in the wire winder. In some embodiments, the electrical signal may include a second electrical signal, and the second electrical signal may include a second feature data generated by the wire recycling action of recycling the wire into the wire winder.

In some embodiments, the action command may include a first action command that has a preset correspondence with the first feature data. In some embodiments, the action command may include a second action command that has a preset correspondence with the second feature data.

In some embodiments, step S1102 may include: determining the action command that has a preset correspondence with the positive and negative polarity of the electrical signal based on the positive and negative polarity of the electrical signal.

In some embodiments, step S1102 may include: determining the action command that has a preset correspondence with the positive and negative polarity sequence based on the positive and negative polarity sequence.

In some embodiments, step S1102 may include: determining the action command that has a preset correspondence with the duration sequence based on the duration sequence.

In some embodiments, step S1102 may include: determining the action command that has a preset correspondence with the interval duration sequence based on the interval duration sequence.

In some embodiments, step S1102 may include: determining the action command that has a preset correspondence with the signal strength sequence based on the signal strength sequence.

In some embodiments, step S1102 may be executed by the electronic device A100, such as the main body A101.
At step S1103: executing the action command to control the electronic device to complete the corresponding operation.

In some embodiments, step S1103 may include: executing a first action command to control the electronic device to display information corresponding to the wire stretching action.

In some embodiments, step S1103 may include: executing a second action command to control the electronic device to display information corresponding to the wire recycling action.

In some embodiments, step S1103 may include: executing the first action command to control the electronic device to display device state and/or power on.

In some embodiments, step S1103 may include: executing the second action command to control the electronic device to display device state and/or shut down.

In some embodiments, the device state may include device battery level or device interaction information or device prompt information. In other embodiments, the device state may also include information corresponding to the wire stretching action, and may also include information corresponding to the wire recycling action. Furthermore, the device state may also include information on the structure and/or internal electronic components of the electronic device A100 that are prone to data changes during use.

In some embodiments, step S1103 may be executed by the electronic device A100, such as the main body A101.

In some embodiments, step S1101 may be continued after step S1103.

In some embodiments, please refer to FIG. 31, the method may also include:
At step S1104, stopping to generate the action command within a preset interval time or stopping to execute the action command.

The settings of step S1104 may prevent the electronic device A100 from frequently displaying or operating, thereby enhancing the user experience.

In some embodiments, step S1104 includes: stopping to execute the last action command of the two adjacent action commands when two adjacent action commands are the same and the interval time is less than or equal to the preset interval time.

In some embodiments, step S1104 may be executed by the electronic device A100, such as the main body A101.

In some embodiments, after step S1102, step S1104 may be executed. In some embodiments, step S1101 may be continued after step S1104.

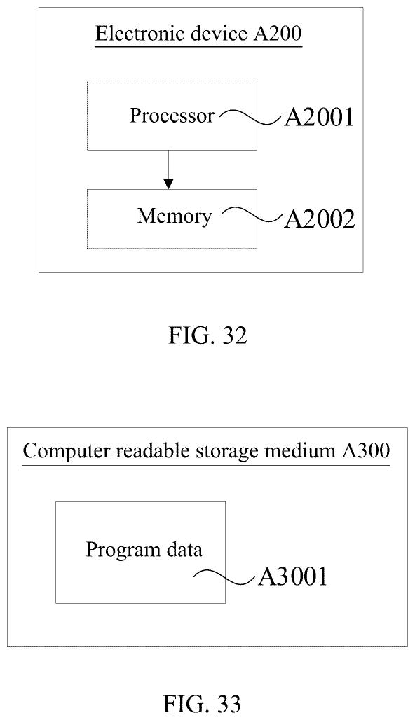

The following will describe an electronic device. FIG. 32 is a schematic diagram of an electronic device in some embodiments of the present application. The electronic device A200 may include a processor A2001 and a memory A2002. The memory A2002 may store computer programs (also known as program data or program code). The processor A2001 is coupled to the memory A2002. The processor A2001 executes the computer programs during operation to implement the method described in the above embodiments.

In some embodiments, the hardware of the electronic device A200 includes but is not limited to a microprocessor, an Application Specific Integrated Circuit (ASIC), and a Field-Programmable Gate Array (FPGA), Digital Signal Processor (DSP), embedded devices, etc. The electronic device A200 may also include network devices and/or user devices. The network devices include but are not limited to a single network server, a server group composed of the plurality of network servers, or a cloud based on cloud computing consisting of a large number of hosts or network servers. The cloud computing is a type of distributed computing, which is a super virtual computer composed of a group of loosely coupled computer sets.

In some embodiments, the electronic device A200 may be, but is not limited to, any kind of electronic product that may interact with the user through a keyboard, touchpad or voice-controlled device, for example, tablet computer, smart phone, personal digital assistant (PDA)Terminals such as PDAs, smart wearable devices, camera equipment, and monitoring devices, and other terminals.

In some embodiments, the Network in which the electronic device A200 is located includes, but is not limited to, the Internet, wide area network, metropolitan area network, local area network, Virtual Private Network (VPN), etc.

In some embodiments, the processor A2001 may be a microprocessor, application specific integrated circuit, programmable gate array, digital processor, etc.

The following will describe a computer readable storage medium. FIG. 33 is a schematic diagram of a computer readable storage medium in some embodiments of the present application. The computer readable storage medium A300 may store program data A3001. When the program data A3001 is executed, the control method based on wire action described in each of the above embodiments may be implemented.

Specifically, in different embodiments, the memory A2002 and/or computer readable storage medium A300 described in the above embodiments may include: USB flash disk, portable hard disk, read-only memory (ROM), random access memory (RAM), floppy disk or optical discs and other medium that may store program codes are not specified here.

Specifically, in different embodiments, the memory A2002 and/or computer readable storage medium A300 described in the above embodiments may be circuits with storage functions that do not have physical forms in integrated circuits, such as Random-Access Memory (RAM), First In First Out (FIFO), etc. Or it may also be a storage device in physical form Storage devices such as memory stick, Trans-flash card (TF card), smart media card, secure digital card, flash card, etc.

In some embodiments, the processor described in the above embodiments may include one or more microprocessors or digital processors. The processor described in the above embodiments may call the program code stored in the memory A2002 and/or computer readable storage medium A300 to perform the relevant functions. The program code stored in the memory A2002 and/or the computer readable storage medium A300 is executed by the processor described in the above embodiments to implement a method. The processor described in the above embodiments is also known as the Central Processing Unit (CPU), which is a very large-scale integrated circuit and is the computing Core (Core) and the Control core (Control Unit).

The above embodiments are only used to illustrate the technical solution of the present application and not to limit it; although the present application has been described in detail with reference to the aforementioned embodiments, those skilled in the art should understand that they may still modify the technical solutions described in the aforementioned embodiments, or equivalently replace some of the technical features; and these modifications or substitutions do not deviate from the essence of the corresponding technical solutions from the scope of the various embodiments of the present application.

In the several embodiments provided in the present application, it should be understood that the disclosed methods and devices may be implemented in other ways. For example, the device implementation described above is only illustrative. For example, the division of modules or units is only a logical functional division. In actual implementation, there may be other division methods, such as the plurality of units or components being combined or integrated into another system, or some features being ignored or not executed.

What is claimed is:

1. A telescopic line module capable of detecting wire action comprising:
an installation housing;
a winding reel rotatably connected in the installation housing and rotates around a rotation axis;
a wire wound on the winding reel, and one end of the wire extended out of the installation housing;
a follower conducting component disposed at the winding reel, and another end of the wire electrically connected to the follower conducting component;
a follower trigger component disposed on the winding reel or the follower conducting component;
wherein when the wire extends out of the installation housing or is retracted into the installation housing, the follower trigger component is configured to cooperate with a fixed detection component to generate an electrical signal reflecting the wire action.

2. The telescopic line module according to claim 1, wherein one of the follower trigger component and the fixed detection component is a magnetic component, and another is a hall element.

3. The telescopic line module according to claim 1, further comprising a fixed detection component, wherein the fixed detection component is disposed on the installation housing.

4. The telescopic line module according to claim 3, wherein the installation housing is provided with the fixed conducting component, the follower conducting component is electrically connected to the fixed conducting component and externally connected through the fixed conducting component, and the fixed detection component is disposed on the fixed conducting component.

5. The telescopic line module according to claim 1, wherein the follower trigger component is grounded, when the wire extends out of the installation housing or is retracted into the installation housing, the follower trigger component is configured to conduct with the fixed detection component, so as to output a grounding electrical signal reflecting the wire action through the fixed detection component.

6. The telescopic line module according to claim 1, wherein the follower trigger components are multiple, and multiple follower trigger components are electrically connected, the fixed detection component comprises a first sub fixed detection component and a second sub fixed detection component, the first sub fixed detection component is grounded or connected to a power terminal, when the winding reel rotates relative to the installation housing, the first sub fixed detection component and the second sub fixed detection component are electrically connected or disconnected through multiple follower trigger components.

7. The telescopic line module according to claim 6, wherein the first sub fixed detection component and the second sub fixed detection component are both two, two first fixed detection components and two second fixed detection components are arranged alternately in a circumferential direction of the rotation axis, or two first fixed detection components and two second fixed detection components are arranged successively in the circumferential direction of the rotation axis.

8. The telescopic line module according to claim 6, wherein the first sub fixed detection component is two, and the second sub fixed detection component is one; or the first sub fixed detection component is one, and the second sub fixed detection component is two.

9. The telescopic line module according to claim 1, wherein the follower trigger components are multiple, multiple follower trigger components comprise a first sub follower detection component and a second sub follower detection component, a distance between the first sub follower detection component and the rotation axis is same as a distance between the second sub follower detection component and the rotation axis, or the distance between the second sub follower detection component and the rotation axis is greater than the distance between the first sub follower detection component and the rotation axis.

10. The telescopic line module according to claim 1, wherein one of the follower trigger component and/or the fixed detection component comprises a trigger component, and another of the follower trigger component and the fixed detection component comprises a plurality of sensors, when the winding reel rotates relatively to the installation housing, the plurality of sensors approach or move away from each other successively with the trigger component, so that the plurality of sensors are triggered successively by the trigger component, and the telescopic line module or an electronic device electrically connected to the follower conducting component obtains the electrical signal of the wire action.

11. The telescopic line module according to claim 10, wherein the plurality of sensors are distributed circumferentially around the rotation axis; distances between some sensors in the plurality of sensors are different, and/or detection indexes of some sensors in the plurality of sensors are different.

12. The telescopic line module according to claim 11, wherein the sensor is a hall sensor, the trigger component is a magnetic component, and the hall sensor is configured to detect magnetic field of the magnetic component.

13. The telescopic line module according to claim 1, wherein the wire action comprises a wire recycling action of the wire being recycled to the installation housing and the wire stretching action of the wire extending out of the installation housing, the telescopic wire module or an electronic device electrically connected to the follower conducting component is configured to generate a first action command corresponding to the wire recycling action based on the electrical signal, and/or generate a second action command corresponding to the wire stretching action based on the electrical signal.

14. A telescopic line module comprising:
a wire;
a rotation wheel connected to the wire, and the wire wound around the rotation wheel or out of the rotation wheel;
a sensing component disposed at the rotation wheel, and the sensing component configured to act with a corresponding trigger component to enable the control module to obtain a winding out signal of the wire when the wire is wound out of the rotation wheel.

15. The telescopic line module according to claim 14, further comprising a follower circuit board, wherein the follower circuit board comprises a first follower end and a second follower end, the first follower end is disposed at the rotation wheel and rotates with the rotation wheel, one end of the wire is electrically connected to the first follower end, and the second follower end is configured for electrical connection with a trigger fixed circuit board.

16. The telescopic line module according to claim 15, further comprising a trigger fixed circuit board, wherein the trigger fixed circuit board comprises a first fixing end and a trigger component, the first fixing end is rotatably connected to the second follower end, and a minimum distance between the trigger component and the first fixing end is greater than 2 millimeters and less than 10 millimeters.

17. The telescopic line module according to claim 14, wherein the sensing component is disposed on one side of the rotation wheel close to the trigger component, and a concave portion is defined on one side of the rotation wheel close to the trigger component, and the sensing component is disposed in the concave portion.

18. An electronic device comprising:
a display module;
a telescopic line module as claimed in claim 14, the display module electrically connected to the sensing component of the telescopic line module, and the display module configured to display the winding out signal of the wire; and
a control module; wherein the display module is electrically connected to the sensing component through the control module, and the control module is configured to obtain the winding out signal of the wire and control the display module to display the winding out signal of the wire.

19. An electronic device capable of detecting wire action comprising:
a main body;
a wire winder, having a winding reel, the winding reel rotatably connected in the main body to rotate around the rotation axis, and the winding reel configured for winding the wire;
a detection module configured to generate an electrical signal when the winding reel rotates relatively to the main body, wherein the electrical signal comprises feature data generated by the wire action on the winding reel;
wherein the main body determines action command based on the feature data and a preset comparison relationship, the action command is executed to control the main body to complete a corresponding operation, and the comparison relationship comprises a preset correspondence between the feature data and the action command.

20. The electronic device capable of detecting wire action according to claim 19, wherein the main body is provided with a fixed conducting component, the winding reel is provided with a follower conducting component, the follower conducting component is electrically connected to the fixed conducting component and is electrically connected to the main body through the fixed conducting component, the detection module comprises a fixed detection component disposed on the fixed conducting component and a follower detection component disposed on the follower conducting component, and the detection module generates an electrical signal reflecting the wire action when the fixed detection component and the follower detection component approach or move away from each other; wherein the wire action comprises a wire recycling action of the wire being recycled to the main body and the wire stretching action of the wire extending out of the main body, the main body is configured to generate a first action command corresponding to the wire recycling action based on the electrical signal, and/or generate a second action command corresponding to the wire stretching action based on the electrical signal;
the first action command comprises at least one of controlling the electronic device to shut down and controlling the electronic device to display indication information corresponding to the wire recycling action;
the second action command comprises at least one of controlling the electronic device to prompt a battery level and controlling the electronic device to display the indication information corresponding to the wire stretching action.
